(19) United States
(12) Patent Application Publication
(10) Pub. No.: US 2026/0273411 A1
(43) Pub. Date: Sep. 17, 2026

(54) VIRTUAL PROP CONTROL METHOD AND APPARATUS, DEVICE, MEDIUM, AND PROGRAM PRODUCT

(71) Applicant: Tencent Technology (Shenzhen) Company Limited, Shenzhen (CN)

(72) Inventor: Ziyi WANG, Shenzhen (CN)

(21) Appl. No.: 19/669,677

(22) Filed: May 6, 2026

Related U.S. Application Data
(63) Continuation of application No. PCT/CN2025/082805, filed on Mar. 17, 2025.

(30) Foreign Application Priority Data
Apr. 24, 2024 (CN) 202410502777.1

(51) Int. Cl. A63F 13/56; A63F 13/2145; A63F 13/533; A63F 13/837; G06F 3/0482; G06F 3/0486; G06F 3/0488

(52) U.S. Cl. CPC A63F 13/56; A63F 13/2145; A63F 13/533; A63F 13/837; G06F 3/0482; G06F 3/0486; G06F 3/0488

(57) ABSTRACT

This application discloses a virtual prop control method performed by a computer device. The method includes: displaying a corresponding pickup manner selection area of a first virtual prop in a virtual scene, the pickup manner comprising at least one of an equipping manner of the first virtual prop and a deployment manner of a consumed prop element during pickup of the first virtual prop, and the consumed prop element being a virtual element consumable by the first virtual prop; and in response to a trigger operation on a first pickup manner in the pickup manner selection area, causing a first virtual character to pick up the first virtual prop based on the first pickup manner. This application provides a pickup manner that enables a human player to control a virtual character to pick up a virtual prop in a graphical user interface more intuitively and therefore improves human-computer interaction efficiency.

### CROSS-REFERENCE TO RELATED APPLICATIONS

This application is a continuation application of PCT Patent Application No. PCT/CN2025/082805, entitled “VIRTUAL PROP CONTROL METHOD AND APPARATUS, DEVICE, MEDIUM, AND PROGRAM PRODUCT” filed on Mar. 17, 2025, which claims priority to Chinese Patent Application No. 2024105027771, entitled "VIRTUAL PROP CONTROL METHOD AND APPARATUS, DEVICE, MEDIUM, AND PROGRAM PRODUCT" filed with the China National Intellectual Property Administration on Apr. 24, 2024, all of which are incorporated herein by reference in their entirety.

### FIELD OF THE TECHNOLOGY

Embodiments of this application relate to the field of computer technologies, and to virtual prop control.

### BACKGROUND OF THE DISCLOSURE

In some games based on virtual scenes, player characters may battle with virtual props, and virtual props randomly appear in virtual scenes for player characters to pick up. When a distance between a player character and a virtual prop in a virtual scene satisfies a pickup requirement, a game application program automatically controls the player character to pick up the virtual prop.

In related art, after approaching the virtual prop that can be picked up, the player character picks up the virtual prop according to a system default pickup rule. For example, after picking up the virtual prop, the player character automatically deploys the virtual prop, and the virtual prop is stored in a prop storage backpack of the player character.

However, the player character may execute an unnecessary deployment action based on the default pickup rule. Besides, a newly picked up virtual prop is stored in a default location in the prop storage backpack, and the player character needs to open a display interface corresponding to the prop storage backpack, to re-adjust a deployment status and the storage location of the virtual prop in the interface, resulting in low human computer interaction efficiency.

### SUMMARY

Embodiments of this application provide a virtual prop control method and apparatus, a device, a medium, and a program product, which can provide an operation option of a pickup way a player controls a virtual character to pick up a virtual prop, so that the player can freely select to avoid subsequent unnecessary adjustment and improve human computer interaction efficiency. The technical solutions are as follows:

According to an aspect, a virtual prop control method is performed by a computer device. The method includes:

displaying a corresponding pickup manner selection area of a first virtual prop in a virtual scene, the pickup manner comprising at least one of an equipping manner of the first virtual prop and a deployment manner of a consumed prop element during pickup of the first virtual prop, and the consumed prop element being a virtual element consumable by the first virtual prop; and

in response to a trigger operation on a first pickup manner in the pickup manner selection area, causing a first virtual character to pick up the first virtual prop based on the first pickup manner.

According to another aspect, a computer device is provided, including a processor and a memory, the memory having a computer program stored therein, and the computer program being loaded and executed by the processor to implement the virtual prop control method according to any foregoing embodiment of this application.

According to another aspect, a non-transitory computer-readable storage medium is provided, the storage medium having a computer program stored therein, and the computer program being loaded and executed by a processor of a computer device and causing the computer device to implement the virtual prop control method according to any foregoing embodiment of this application.

The technical solutions provided in the embodiments of this application include at least the following beneficial effects:

The first virtual character and the first virtual prop in the virtual scene are displayed, and the corresponding pickup manner selection area of the first virtual prop is displayed when the first virtual character and the first virtual prop satisfy the prop pickup requirement. The pickup manner selection area can provide the first virtual character with a pickup manner option of picking up the first virtual prop. Setting information such as the equipping manner of the picked-up first virtual prop and the deployment manner of the consumed prop element during pickup of the first virtual prop is determined, so that the first virtual character immediately determines how to control/use the first virtual prop when obtaining the first virtual prop. That the first virtual character picks up the first virtual prop based on the first pickup manner is displayed in response to the trigger operation on the first pickup manner in the pickup manner selection area. Compared with the way the first virtual character picks up the first virtual prop based on the default pickup rule, the present application avoids that the first virtual character performs an unnecessary equipping or deployment operation during pickup of the first virtual prop. This not only effectively reduces several times a system responds to user operations and improve system resource utilization, but also improves degrees of freedom and flexibility of operations of a player. Besides, this can avoid time consumption caused when the player re-adjusts the prop through the user interface because the default pickup rule does not conform to a manner preferred by the player, and can improve human computer interaction efficiency.

### BRIEF DESCRIPTION OF THE DRAWINGS

FIG. 1 is a structural block diagram of an electronic device according to an exemplary embodiment of this application;

FIG. 2 is a structural block diagram of a computer system according to an exemplary embodiment of this application;

FIG. 3 is a flowchart of a virtual prop control method according to an exemplary embodiment of this application;

FIG. 4 is a schematic diagram of a pickup manner selection area according to an exemplary embodiment of this application;

FIG. 5 is a schematic diagram of displaying a consumed element deployment control in different display manners after being triggered according to an exemplary embodiment of this application;

FIG. 6 is a schematic diagram of displaying an automatic equipping control in different display manners after being triggered according to an exemplary embodiment of this application;

FIG. 7 is a schematic diagram of a prop equipping area according to an exemplary embodiment of this application;

FIG. 8 is a schematic diagram of a primary prop slot and a secondary prop slot according to an exemplary embodiment of this application;

FIG. 9 is a flowchart of a virtual prop control method according to another exemplary embodiment of this application;

FIG. 10 is a schematic diagram of discarding a first virtual prop based on a first slide operation according to another exemplary embodiment of this application;

FIG. 11 is a schematic diagram of exchanging virtual props in different prop sub-areas in display based on a second slide operation according to an exemplary embodiment of this application;

FIG. 12 is a schematic diagram of controlling several consumed prop elements based on a consumed prop element control according to an exemplary embodiment of this application;

FIG. 13 is a schematic diagram of establishing a binding relationship based on a binding control according to an exemplary embodiment of this application;

FIG. 14 is a flowchart of a virtual element control method according to an exemplary embodiment of this application;

FIG. 15 is a flowchart of an operation based on a pickup manner selection area according to an exemplary embodiment of this application;

FIG. 16 is a flowchart of an operation based on a prop equipping area according to an exemplary embodiment of this application;

FIG. 17 is a flowchart of controlling a consumed prop element and a virtual prop based on a prop equipping area according to an exemplary embodiment of this application;

FIG. 18 is a structural block diagram of a virtual prop control apparatus according to an exemplary embodiment of this application;

FIG. 19 is a structural block diagram of a virtual prop control apparatus according to another exemplary embodiment of this application; and

FIG. 20 is a structural block diagram of a computer device according to an exemplary embodiment of this application.

### DESCRIPTION OF EMBODIMENTS

To make the objectives, technical solutions, and advantages of this application clearer, the following further describes implementations of this application in detail with reference to the accompanying drawings.

Exemplary embodiments are described in detail herein, and examples of the exemplary embodiments are shown in the accompanying drawings. When the following description involves the accompanying drawings, unless otherwise indicated, the same numerals in different accompanying drawings represent the same or similar elements. The following implementations described in the following exemplary embodiments do not represent all implementations that are consistent with this application. Instead, the following implementations are merely examples of the apparatus and method according to some aspects of this application as recited in the appended claims.

The terms used in this application are for the purpose of describing specific embodiments only and are not intended to limit this application. The terms "a", "said" and "the" of singular forms used in this application and the appended claims are also intended to include plural forms, unless otherwise specified in the context clearly. The term "and/or" used herein indicates and includes any or all combinations of one or more associated listed items.

Information and data involved in this application are all authorized by users or are fully authorized by all parties, and collection, use, and processing of related data need to comply with related laws and regulations and standards of related countries and regions.

Although terms "first", "second", and the like may be used in this application to describe various pieces of information, these pieces of information are not limited by the terms. These terms are merely used to differentiate the same type of information. For example, without departing from the scope of this application, a first parameter may also be referred to as a second parameter, and similarly, a second parameter may also be referred to as a first parameter. Depending on the context, for example, the word "if" used herein may be interpreted as "in a case" or "when" or "in response to determination".

First, terms in the embodiments of this application are briefly introduced.

Virtual character/virtual object: A virtual character/virtual object is a movable object in a virtual scene. The movable object may be a virtual object, a virtual animal, an animation person, or the like, such as a person, an animal, a plant, an oil drum, a wall, and a rock displayed in a three-dimensional virtual scene. In an embodiment, the virtual object is a three-dimensional model created based on a skeletal animation technology. Each virtual object has a shape and a volume in the three-dimensional virtual scene, and occupies a part of a space in the three-dimensional virtual scene.

Virtual scene: A virtual scene is displayed (or provided) when an application program runs on a terminal. The virtual scene may be a simulated scene of a real scenario, or a semi-simulated and semi-fictional scene, or a purely fictional scene. The virtual scene may be any one of a two-dimensional virtual scene, a 2.5-dimensional virtual scene, or a three-dimensional virtual scene. This is not limited in this application. In the following embodiments, for example, the virtual scene is a three-dimensional virtual scene.

"In response to": "In response to" is used for representing a condition or a status on which an executed operation depends, and when a dependent condition or status is satisfied, one or more executed operations may be in real time or may have a specified delay. There is no limitation on a sequence in which multiple operations are performed without description.

In some games based on virtual scenes, players control virtual characters to perform virtual battles, and the virtual characters may use virtual props during the battles. For example, in a shooting game, a virtual prop enables a virtual character to have an attack capability/defense capability, thereby improving a battle win rate.

A manner of obtaining a virtual prop includes but is not limited to: (1) A virtual prop randomly appears in a virtual scene for a virtual character to pick up. (2) A virtual prop is exchanged with a virtual resource in a game exchange store. (3) Virtual characters present existing virtual props to each other.

In this application, a virtual prop randomly appears in a virtual scene for a player to control a virtual character to obtain the prop.

In the related art, when a distance between a virtual character and a virtual prop in a virtual scene satisfies a pickup requirement, a game system automatically controls the virtual character to pick up the virtual prop according to a default pickup rule, that is, an action type executed by the virtual character when picking up the virtual prop, a storage location of the virtual prop after pickup, and the like are also defaulted in the system.

For example, the virtual prop picked up by the virtual character is a virtual shooting prop, and after picking up the virtual shooting prop, the virtual character automatically equips the virtual prop and equips the virtual shooting prop with a virtual bullet element. In addition, the virtual prop may be stored in a prop storage backpack of the virtual character.

However, the virtual character may execute an unnecessary deployment action based on the default pickup rule. Besides, a newly picked up virtual prop is stored in a default location in the prop storage backpack, and the default location may be different from a storage location preferred by a player. The player needs to reopen a display interface corresponding to the prop storage backpack, to re-adjust a deployment status and the storage location of the virtual prop in the interface, resulting in low human computer interaction efficiency.

This application provides a virtual prop control method, which can display a pickup manner option when a virtual character picks up a virtual prop. The pickup manner option provides the virtual character with multiple pickup manners of picking up the virtual prop. The pickup manner includes at least one of whether the virtual character directly equips the virtual prop when picking up the virtual prop, whether to deploy the virtual prop by using an existing consumed prop element, a storage location of the virtual prop, and the like, which can provide full operation selection for the player. When the player controls the virtual character to pick up the virtual prop, related settings of the virtual prop are completed. It is avoided that an interface for adjusting a virtual prop is subsequently opened to set the virtual prop again.

For a virtual prop that is no longer needed by the virtual character, the player may further operate in a prop equipping area that is regularly displayed on a display screen of a terminal, to control the virtual character to directly discard the virtual prop. Compared with the related-art manner of switching an interface of a prop storage backpack and an interface of a virtual battle back and forth, to control a number, locations, and the like of virtual props, human computer interaction efficiency can be improved.

The terminal in this application may be a desktop computer, a laptop portable computer, a smartphone, a tablet computer, an ebook reader, a moving picture experts group audio layer III (MP3) player, a moving picture experts group audio layer IV (MP4) player, or the like. An application program supporting a virtual scene is installed and run on the terminal, for example, an application program that supports a 3-dimensional virtual scene. The application program may be any one of a virtual reality application program, a three-dimensional map program, a Massive Multiplayer Online Role-Playing Game (MMORPG), a strategy game (SLG), a third-person shooter game (TPS), a first-person shooter game (FPS), a multiplayer online battle arena game (MOBA), a party recreation game, a tower defense game, or a social game. In an embodiment, the application program may be a standalone application program, such as a standalone three-dimensional game program, or may be an online application program.

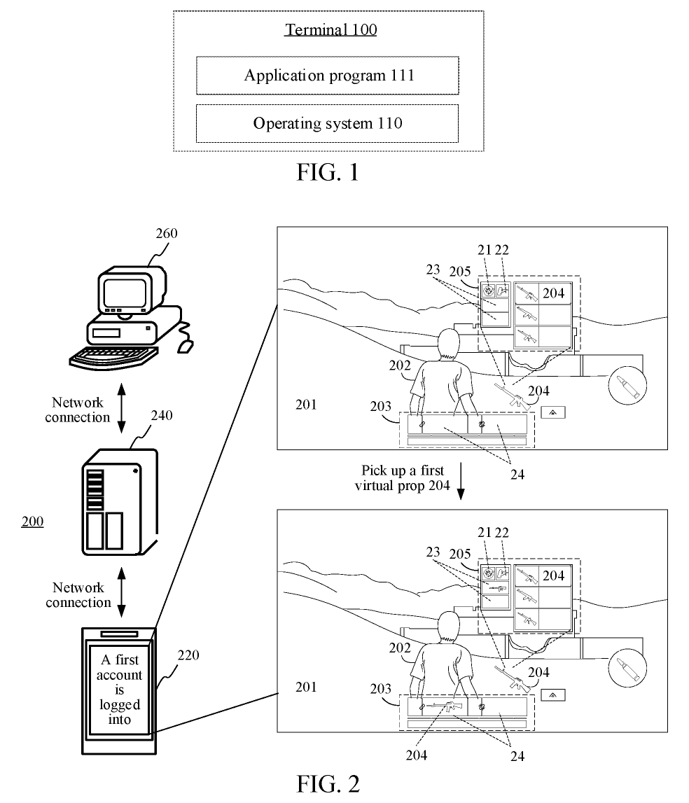

FIG. 1 is a structural block diagram of an electronic device according to an exemplary embodiment of this application. The electronic device 100 includes: an operating system 110 and an application program 111.

The operating system 110 is basic software that provides secure access to computer hardware for the application program 111.

The application program 111 is an application program supporting a virtual scene. In an embodiment, the application program 111 is an application program supporting a three-dimensional virtual scene. The application program 111 may be any one of a virtual reality application program, a three-dimensional map program, an MMORPG game, an SLG game, a TPS game, an FPS game, an MOBA game, a party recreation game, a tower defense game, or a social game. The application program 111 may be a standalone application program, such as a standalone three-dimensional game program, or may be an online application program.

FIG. 2 is a structural block diagram of a computer system according to an exemplary embodiment of this application. The computer system 200 includes a first device 220, a server 240, and a second device 260.

An application program supporting a virtual scene is installed and run on the first device 220. The application program may be any one of a virtual reality application program, a three-dimensional map program, an MMORPG game, a TPS game, an FPS game, an MOBA game, an SLG game, a party game, and a tower defense game. The first device 220 is a device used by a first user. The first user uses the first device 220 to control a first virtual character in a virtual scene to perform an activity. The activity includes, but is not limited to, at least one of adjusting a body posture, walking, running, jumping, and attacking. Exemplarily, the first virtual character is a first virtual person, for example, a simulated character or an animation character.

The first device 220 is connected to the server 240 through a wireless network or a wired network.

The server 240 includes at least one of one server, multiple servers, a cloud computing platform, or a virtualization center. The server 240 is configured to provide a backend service for an application program supporting a three-dimensional virtual scene. In an embodiment, the server 240 performs primary computing work, and the first device 220 and the second device 260 perform secondary computing work. Alternatively, the server 240 performs secondary computing work, and the first device 220 and the second device 260 perform primary computing work. Alternatively, the server 240, the first device 220, and the second device 260 perform collaborative computation based on a distributed computing architecture.

The server 240 controls a second virtual character in a virtual scene to perform an activity. The activity includes, but is not limited to, at least one of adjusting a body posture, walking, running, jumping, and attacking. Exemplarily, the second virtual character is a second virtual person, for example, a simulated character or an animation character.

An application program supporting a virtual scene is installed and run on the second device 260. The application program may be any one of a virtual reality application program, a three-dimensional map program, an FPS game, an MOBA game, an SLG game, a party game, and a tower defense game. The second device 260 is a device used by a second user. The second user uses the second device 260 to control a third virtual character in a virtual scene to perform an activity. The activity includes, but is not limited to, at least one of adjusting a body posture, walking, running, jumping, and attacking. Exemplarily, the third virtual character is a third virtual person, for example, a simulated character or an animation character.

In an embodiment, the virtual scene further includes a virtual building, a virtual obstacle, a virtual prop, a virtual object, and the like. The first user controls, by using the first device 220, the first virtual character to enter a virtual building to perform an activity. Alternatively, the first user controls, by using the first device 220, the first virtual character to block movement of the second virtual character by using a virtual obstacle. Alternatively, the first user controls, by using the first device 220, the first virtual character to use a virtual prop to interact with the second virtual character, for example, to perform behaviors such as attacking or defending.

In an embodiment, the application programs installed on the first device 220 and the second device 260 are the same, or the application programs installed on the two devices are the same type of application programs on different control system platforms. The first device 220 may refer to one of multiple devices, and the second device 260 may refer to one of multiple devices. In this embodiment, only the first device 220 and the second device 260 are used as an example for description. Device types of the first device 220 and the second device 260 are the same or different. In the following embodiments, for example, the device is a desktop computer.

In an embodiment, a first account is logged into on the first device 220, a second account is logged into on the second device 260, and the first device 220 sends equipping assistance request information to the second device 260. The equipping assistance request information is used to request the second account to recommend virtual equipping to the first account. The virtual equipping may be equipping for the first virtual character controlled by the first account. The first device 220 sends the equipping assistance request information to the second device 260, and the screen of the first device 220 correspondingly displays an equipping configuration interface. The second device 260 receives the equipping assistance request information from the first device 220, and the screen of the second device 260 also correspondingly displays an equipping configuration interface.

In an embodiment, the display screen of the first device 220 displays a virtual scene 201 and a first virtual character 202 controlled by the first user by using the first account, and the first virtual character 202 is in the virtual scene 201.

The display screen of the first device 220 regularly displays a prop equipping area 203, and the prop equipping area 203 includes multiple prop sub-areas for displaying a status of a virtual prop owned by the first virtual character 202.

A first virtual prop 204 further exists in the virtual scene 201, and a pickup manner selection area 205 is displayed when the first virtual character 202 and the first virtual prop 204 satisfy a prop pickup requirement.

The pickup manner selection area 205 includes a consumed element deployment control 21, an automatic prop equipping control 22, and a prop sequence slot 23. The first user may determine, by using the pickup manner selection area 205, a pickup way the first virtual character 202 picks up the first virtual prop 204.

For example, after the automatic prop equipping control 22 is triggered, the first virtual character 202 may be controlled to automatically equip with the first virtual prop 204 after picking up the first virtual prop 204. For example, the first virtual prop 204 is a virtual shooting prop, and after picking up the virtual shooting prop, the first virtual character 202 performs a gun pulling action.

After the consumed element deployment control 21 is triggered, the first virtual character 202 may be controlled to automatically deploy the first virtual prop 204 based on a consumed prop element after picking up the first virtual prop 204. For example, the first virtual prop 204 is a virtual shooting prop, the consumed prop element is a virtual bullet element, and after picking up the virtual shooting prop, the first virtual character 202 reloads the virtual shooting prop based on the virtual bullet element.

There is a correspondence between the prop sequence slot 23 in the pickup manner selection area 205 and a prop sub-area 24 in the prop equipping area 203. For example, the prop sequence slot 23 includes a primary prop slot and a secondary prop slot, and the prop sub-area 24 includes a first sub-area and a second sub-area. If the first user drags the first virtual prop 204 to the primary prop slot, after the first virtual character 202 picks up the first virtual prop 204, the first virtual prop 204 is automatically displayed in the first sub-area. If the first user drags the first virtual prop 204 to the secondary prop slot, after the first virtual character 202 picks up the first virtual prop 204, the first virtual prop 204 is automatically displayed in the second sub-area.

A person skilled in the art may understand that more or fewer devices may be provided. For example, there may be only one device, or there may be dozens or hundreds of devices, or more devices. A quantity of devices and the device type are not limited in the embodiments of this application.

The server 240 can be implemented as a physical server or a cloud server in the cloud. The cloud technology is a hosting technology that unifies a series of resources such as hardware, software, and networks in a wide area network or a local area network to implement computing, storage, processing, and sharing of data. The cloud technology is a general term for a network technology, an information technology, an integration technology, a management platform technology, an application technology, and the like applied based on the business mode of cloud computing, and may form a resource pool used on demand flexibly and conveniently. The cloud computing technology will become an important support. The background service of a technical network system requires many computing and storage resources, for example, video websites, image websites, and more portal websites. With rapid development and application of the Internet industry, in the future, each item may have an identifier, all identifiers need to be transmitted to a background system for logical processing, data at different levels will be processed separately, and all types of industry data require powerful system support. This can be implemented only through cloud computing. In an embodiment, when the server 240 is implemented as a cloud server, the program corresponding to the virtual scene may be a cloud game.

In some embodiments, the method provided in this embodiment of this application may be applied to a cloud game scenario, so that a cloud server completes computing of data logic in a game process, and a terminal is responsible for displaying a game interface.

In an embodiment, the server 240 can also be implemented as a node in a blockchain system.

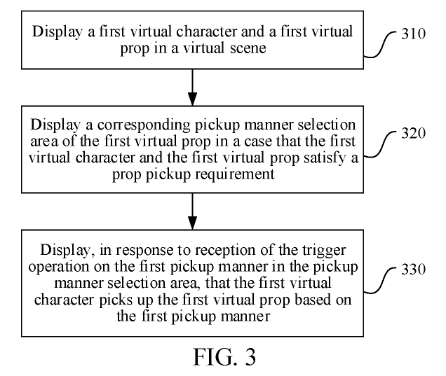

The virtual prop control method provided in this application is described with reference to the foregoing brief description of terminologies and application scenarios. The method may be performed by a computer device. The computer device may include at least one of the foregoing server or terminal. In this embodiment, specifically, the method may be performed by the server or the terminal, or may be performed jointly by the server and terminal. In an embodiment of this application, for example, the method is performed by a terminal. As shown in FIG. 3, FIG. 3 is a flowchart of a virtual prop control method according to an exemplary embodiment of this application. The method includes the following operations:

Operation 310: Display a first virtual character and a first virtual prop in a virtual scene.

The first virtual character is a virtual character controlled by a first player account.

In an embodiment, a game system may randomly grant a virtual prop in a virtual scene to be obtained by a virtual character controlled by a player. A grant location of the virtual prop in the virtual scene may be any location or may be designated. Alternatively, a virtual character controlled by another player account may discard an owned virtual prop in a designated location or any location in a virtual scene.

Exemplarily, the first virtual prop is a virtual prop randomly appearing in the virtual scene, and the first player account may control the first virtual character to pick up the first virtual prop.

Exemplarily, the first virtual prop is used to provide a shooting prop function for the first virtual character, that is, when the first virtual character performs a virtual battle with another virtual character, the first virtual character may perform a shooting action based on the first virtual prop, to attack the another virtual character.

Operation 320: Display a corresponding pickup manner selection area of the first virtual prop when the first virtual character and the first virtual prop satisfy a prop pickup requirement.

The pickup manner selection area is used to provide the first virtual character with a pickup manner of picking up the first virtual prop.

In an embodiment, the prop pickup requirement of a virtual character and a virtual prop is as follows: a distance between the virtual character and the virtual prop is less than or equal to a preset distance threshold.

For example, the preset distance threshold is 3 distance units. When the distance between the first virtual character and the first virtual prop is 2 distance units, this distance is less than the preset distance threshold, and the prop pickup requirement is satisfied.

The pickup manner selection area is displayed based on a distance between a virtual character and a virtual prop, so that a player can be prompted to pick up a virtual prop in time when a virtual character approaches the virtual prop. In this way, the player can focus on a virtual battle, thereby improving a battle win rate of the player. Besides, this can reduce operating pressure and time of simultaneously controlling the virtual character and searching for a virtual prop by the player, to improve game experience of the player.

In an embodiment, the pickup manner includes at least one of an equipping manner of the picked-up first virtual prop and a deployment manner of a consumed prop element during pickup of the first virtual prop. The consumed prop element is a virtual element consumable by the first virtual prop when the first virtual prop implements a prop function.

The equipping manner of the first virtual prop is determined based on a prop type of the first virtual prop.

Exemplarily, the first virtual prop is a virtual shooting prop. The first virtual character may immediately equip the first virtual prop when picking up the first virtual prop, or may store the first virtual prop in a prop storage backpack after picking up the first virtual prop, and does not immediately equip the first virtual prop.

When equipping the first virtual prop, the first virtual character may choose to pull and equip the first virtual prop from the front of the character, and remain in a state of holding the first virtual prop. Alternatively, the first virtual character may choose to pull and equip the first virtual prop from behind the character, and remain in a state of holding the first virtual prop.

The deployment manner of the consumed prop element during pickup of the first virtual prop is determined based on a prop type of the first virtual prop. Exemplarily, if the first virtual prop is a virtual shooting prop, the consumed prop element is a bullet element matching the first virtual prop, and the first virtual prop needs to consume the bullet element when performing a shooting function. Therefore, the first virtual prop needs to be loaded with bullets before implementing the prop function.

If the first virtual character has a consumed prop element matching the first virtual prop, the first virtual character may choose to deploy the first virtual prop with the existing consumed prop element during pickup of the first virtual prop. Alternatively, the first virtual character may choose temporarily not to deploy the first virtual prop with the existing consumed prop element during pickup of the first virtual prop. If the first virtual character temporarily does not have the consumed prop element matching the first virtual prop, the first virtual character cannot deploy the first virtual prop with the consumed prop element.

The prop owned by the first virtual character is stored in the prop storage backpack. In some embodiments, the pickup manner further includes storing the first virtual prop in a storage location of the prop storage backpack after the first virtual prop is picked up. The storage location of the first virtual prop is associated with a sequence of the first virtual character using virtual props in the virtual battle.

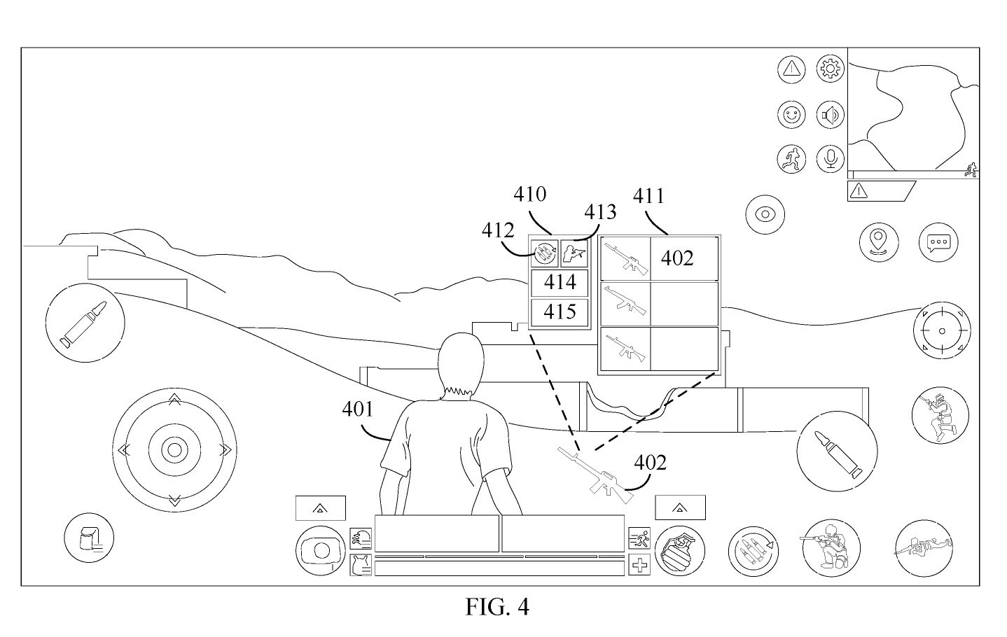

Exemplarily, as shown in FIG. 4, FIG. 4 is a schematic diagram of the pickup manner selection area.

When a first virtual object 401 approaches a first virtual prop 402, a pickup manner selection area 410 corresponding to the first virtual prop 402 is automatically displayed. The pickup manner selection area 410 includes a virtual prop candidate list 411. The virtual prop candidate list 411 displays a candidate virtual prop that satisfies the prop pickup requirement together with the first virtual object 401. In this embodiment, a prop identifier corresponding to the first virtual prop 402 is displayed in the virtual prop candidate list 411, and indicates that the first virtual prop 402 and the first virtual character 401 satisfy the prop pickup requirement.

Operation 330: Display, in response to a trigger operation on a first pickup manner in the pickup manner selection area, that the first virtual character picks up the first virtual prop based on the first pickup manner. In other words, the computer device causes the first virtual character to pick up the first virtual prop based on the first pickup manner.

In an embodiment, in response to a consumed element deployment operation in the pickup manner selection area, that the first virtual character picks up the first virtual prop is displayed, and the first virtual prop is deployed based on the consumed prop element.

Exemplarily, the pickup manner selection area includes a consumed element deployment control. After a trigger operation on the consumed element deployment control is received, that the first virtual character picks up the first virtual prop is displayed, and the first virtual prop is deployed based on the consumed prop element. In this example, the first pickup manner may be a consumed element deployment manner selected by using a consumed element deployment operation.

As shown in FIG. 4, the pickup manner selection area 410 includes a consumed element deployment control 412. After the consumed element deployment control 412 is triggered, a consumed element deployment function is enabled, that is, when the first virtual character 401 picks up the first virtual prop 402, the first virtual prop 402 is automatically deployed with an owned consumed prop element.

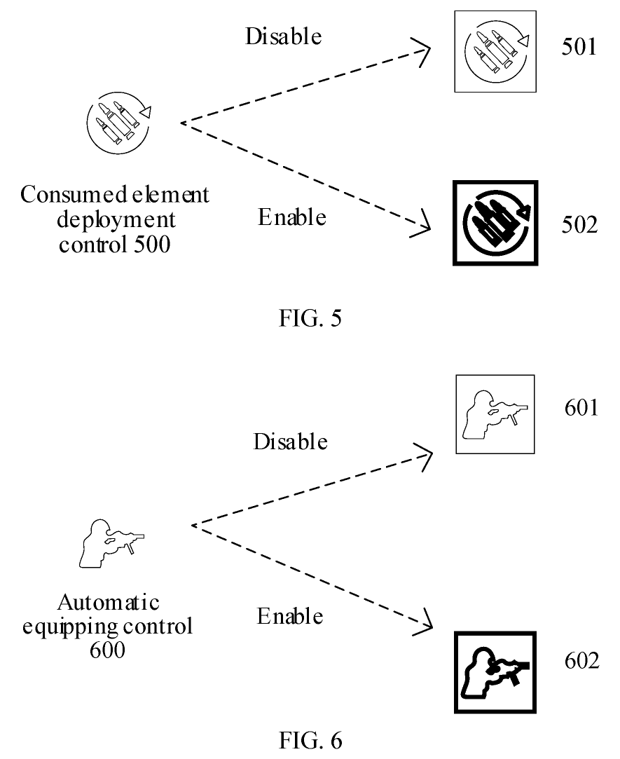

In some embodiments, the consumed element deployment function may be disabled by triggering the consumed element deployment control again. Referring to FIG. 5, FIG. 5 is a schematic diagram of displaying a consumed element deployment control in different display manners after being triggered.

At an initial moment, that is, when a player has not triggered a consumed element deployment control 500, the consumed element deployment function is not enabled by default, and the consumed element deployment control 500 is displayed in a first display manner 501. In this case, the consumed element deployment control 500 is triggered to enable the consumed element deployment function, and the consumed element deployment control 500 is displayed in a second display manner 502. The consumed element deployment control 500 is triggered again to disable the consumed element deployment function, and the consumed element deployment control 500 is displayed in the first display manner 501 again.

That is, each time the consumed element deployment control 500 is triggered, a display manner of the consumed element deployment control 500 and an enabled/disabled state of the consumed element deployment function are changed once.

Exemplarily, a difference between the first display manner and the second display manner lies in display brightness. Display brightness corresponding to the first display manner is lower than display brightness corresponding to the second display manner.

An operation type of the consumed element deployment operation may be any type, and the first display manner and the second display manner may be any different display manners.

The pickup manner selection area provides an option of deploying the virtual prop with an existing consumed prop element, so that when a player controls a virtual character to pick up the virtual prop, the virtual prop can be immediately equipped with the consumed prop element. The deployed virtual prop may be immediately used in a virtual battle, implementing a prop function and improving human computer interaction efficiency and a game win rate of the player.

In an embodiment, in response to an automatic prop equipping operation in the pickup manner selection area, that first virtual character picks up the first virtual prop is displayed, and the first virtual prop is automatically equipped. In this example, the first pickup manner may be an automatic prop equipping manner selected by using an automatic prop equipping operation.

Exemplarily, the pickup manner selection area includes an automatic equipping control. After the trigger operation on the automatic equipping control is received, that the first virtual character picks up the first virtual prop is displayed, and the first virtual prop is automatically equipped.

As shown in FIG. 4, the pickup manner selection area 410 includes an automatic equipping control 413. After the automatic equipping control 413 is triggered, an automatic prop equipping function is enabled, that is, when the first virtual character 401 picks up the first virtual prop 402, the first virtual prop 402 is automatically equipped.

In some embodiments, the automatic prop equipping function may be disabled by triggering the automatic equipping control again. Referring to FIG. 6, FIG. 6 is a schematic diagram of displaying the automatic equipping control in different display manners after being triggered.

At an initial moment, that is, when a player has not triggered an automatic equipping control 600, the automatic prop equipping function is not enabled by default, and the automatic equipping control 600 is displayed in a third display manner 601. In this case, the automatic equipping control 600 is triggered to enable the automatic prop equipping function, and the automatic equipping control 600 is displayed in a fourth display manner 602. The automatic equipping control 600 is triggered again to disable the automatic prop equipping function, and the automatic equipping control 600 is displayed in the third display manner 601 again.

That is, each time the automatic equipping control 600 is triggered, a display manner of the automatic equipping control 600 and an enabled/disabled state of the automatic prop equipping function are changed once.

Exemplarily, a difference between the third display manner and the fourth display manner lies in display brightness. Display brightness corresponding to the third display manner is lower than display brightness corresponding to the fourth display manner.

An operation type of the automatic prop equipping operation may be any type, and the third display manner and the fourth display manner may be any different display manners.

The pickup manner selection area provides an option of automatically equipping the virtual prop, so that a virtual character picks up the virtual prop, and the virtual prop can be immediately equipped. When needing to use the virtual prop for a virtual battle, a player can directly perform relevant operations and invoke the prop function of the virtual prop, improving human computer interaction efficiency and a game win rate of the player.

The automatic prop equipping function and the consumed element deployment function are two functions in parallel. According to an enabled/disabled state of each function, action types performed when the first virtual character picks up the first virtual prop may be different, and include the following several cases.
(1) When the automatic prop equipping function is enabled and the consumed element deployment function is enabled: the first virtual character first picks up the first virtual prop, equips the first virtual prop, deploys the first virtual prop based on the consumed prop element, and maintains a status of the equipped first virtual prop after deployment.
(2) When the automatic prop equipping function is enabled and the consumed element deployment function is not enabled: the first virtual character first picks up the first virtual prop, equips the first virtual prop, and maintains a status of the equipped first virtual prop.
(3) When the automatic prop equipping function is not enabled and the consumed element deployment function is enabled: the first virtual character first picks up the first virtual prop, equips the first virtual prop, deploys the first virtual prop based on the consumed prop element, cancels equipping of the first virtual prop after deployment, and stores the first virtual prop in the prop storage backpack.
(4) When the automatic prop equipping function is not enabled and the consumed element deployment function is not enabled: the first virtual character picks up the first virtual prop, and directly stores the first virtual prop in the prop storage backpack.

In an embodiment, the pickup manner selection area includes multiple prop sequence slots, the multiple prop sequence slots correspond to different sequence numbers, and the multiple prop sequence slots are used to indicate an equipping sequence of using virtual props by the first virtual object.

Exemplarily, as shown in FIG. 4, the pickup manner selection area 410 includes two prop sequence slots, which are respectively a primary prop slot 414 and a secondary prop slot 415. The primary prop slot 414 corresponds to a sequence number 1. The secondary prop slot 415 corresponds to a sequence number 2.

In an embodiment, a prop equipping area is regularly displayed, where the prop equipping area is used to display a virtual prop owned by the first virtual character.

In an embodiment, the prop equipping area includes multiple prop sub-areas, an i^{th} prop sub-area corresponds to an i^{th} prop sequence slot in the pickup manner selection area, and i is a positive integer. The i^{th} prop sub-area is one of multiple prop sub-areas, and a number of prop sub-areas is the same as a number of prop sequence slots.

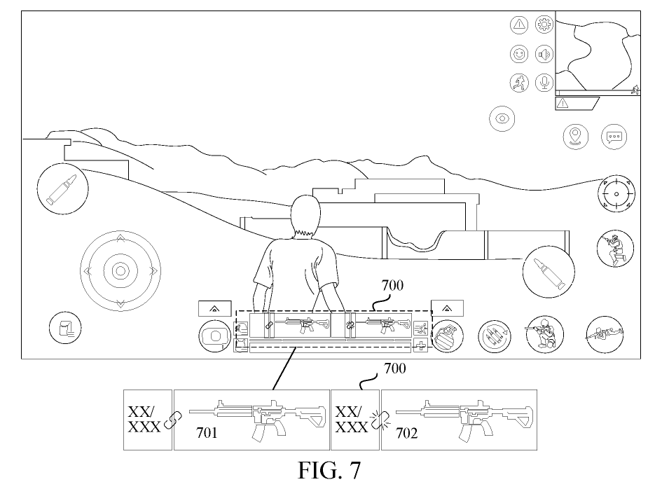

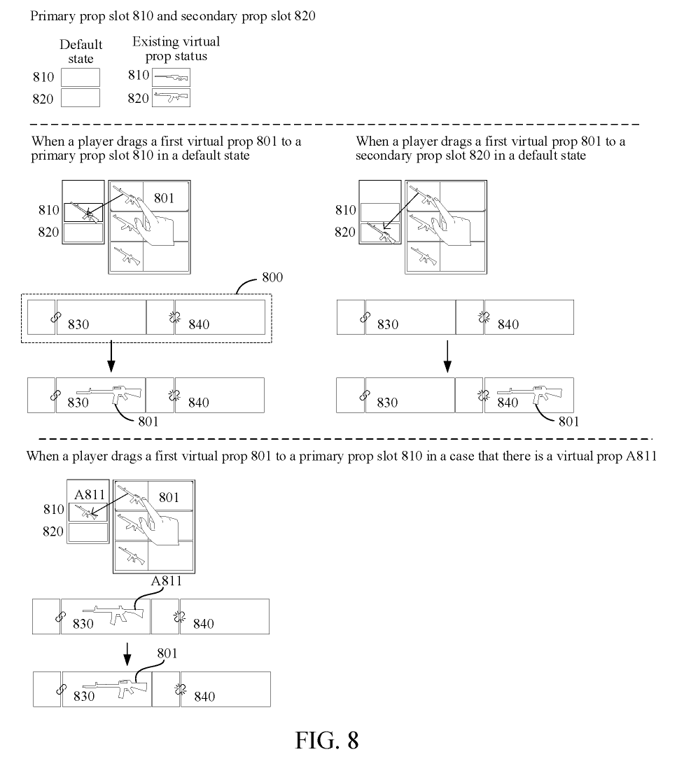

Exemplarily, as shown in FIG. 7, FIG. 7 is a schematic diagram of a prop equipping area.

A prop equipping area 700 corresponds to the pickup manner selection area 410 in FIG. 4. That is, the prop equipping area 700 includes two prop sub-areas: a first sub-area 701 corresponds to the primary prop slot 414, and a second sub-area 702 corresponds to the secondary prop slot 415.

In some embodiments, when the first virtual prop is located in the primary prop slot and the secondary prop slot, action types of the first virtual character during equipping of the first virtual prop are different.

For example, the first virtual prop is a virtual shooting prop. When equipping the first virtual prop, if the first virtual prop is in the first sub-area (that is, the first virtual prop corresponds to the primary prop slot), the first virtual character pulls the first virtual prop from the front of the character for equipping, and maintains a status of holding the first virtual prop. If the first virtual prop is in the second sub-area (that is, the first virtual prop corresponds to the secondary prop slot), the first virtual character pulls the first virtual prop from behind the character for equipping, and maintains a status of holding the first virtual prop.

In an embodiment, the first virtual character picks up the first virtual prop is displayed in response to a prop sequence setting operation in the pickup manner selection area. After the first virtual character picks up the first virtual prop, the first virtual prop is displayed in the prop equipping area based on an equipping sequence indicated by the prop sequence setting operation.

Exemplarily, a dragging operation on the first virtual prop is received, where the dragging operation is used to drag the first virtual prop to a j^{th} prop sequence slot, and j is a positive integer. That the first virtual character picks up the first virtual prop based on the dragging operation is displayed. The first virtual prop is displayed in a j^{th} prop sub-area in the prop equipping area.

Exemplarily, referring to FIG. 8, there is no virtual prop in both a primary prop slot 810 (a first prop sequence slot) and a secondary prop slot 820 (a second prop sequence slot) in a default state. When there is a virtual prop, a prop identifier of the virtual prop is correspondingly displayed in the primary prop slot 810 and the secondary prop slot 820, and the prop identifier of the virtual prop is also correspondingly displayed in a corresponding first prop sub-area 830 and a corresponding second prop sub-area 840.

The prop identifier is used to uniquely indicate a virtual prop, and includes at least one of the following types of information: a prop appearance, a prop name, a prop type, and the like.

For example, a first virtual prop 801 is dragged to the primary prop slot 810, a prop identifier of the first virtual prop 801 is displayed in the primary prop slot 810, and the prop identifier of the first virtual prop 801 is also correspondingly displayed in the first prop sub-area 830 in a prop equipping area 800. The first virtual prop 801 is dragged to the secondary prop slot 820, the prop identifier of the first virtual prop 801 is displayed in the secondary prop slot 820, and the prop identifier of the first virtual prop 801 is also correspondingly displayed in the second prop sub-area 840 in the prop equipping area 800.

The pickup manner selection area provides an option of the prop sequence slot, so that a storage location of the virtual prop can be determined when the virtual character picks up the virtual prop. It is avoided that a player changes a location of the virtual prop by subsequently opening an adjustment interface of the virtual prop, thereby improving human computer interaction efficiency.

In some embodiments, if there is a virtual prop in the prop slot and the first virtual prop is dragged to the prop slot of the existing virtual prop, the original virtual prop in the prop slot is replaced with the first virtual prop, and the original virtual prop may be discarded in a virtual scene.

For example, there is a virtual prop A811 in the primary prop slot 810, and the first virtual prop 801 is dragged to the primary prop slot 810. In this case, a prop identifier of the virtual prop A811 originally located in the primary prop slot 810 and the first prop sub-area 830 is replaced with the prop identifier of the first virtual prop 801.

Several prop sub-areas included in the prop equipping area corresponds to several prop sequence slots in the pickup manner selection area. The number of prop sequence slots may be any number, and an equipping sequence of a virtual prop corresponding to each prop sequence slot may be determined in any manner. This is not limited in this embodiment.

In conclusion, in the method provided in this application, the first virtual character and the first virtual prop in the virtual scene are displayed, and the corresponding pickup manner selection area of the first virtual prop is displayed when the first virtual character and the first virtual prop satisfy the prop pickup requirement. The pickup manner selection area can provide the first virtual character with a pickup manner option of picking up the first virtual prop. Setting information such as the equipping manner of the picked-up first virtual prop and the deployment manner of the consumed prop element during pickup of the first virtual prop is determined, so that the first virtual character immediately determines how to control/use the first virtual prop when obtaining the first virtual prop. That the first virtual character picks up the first virtual prop based on the first pickup manner is displayed in response to the trigger operation on the first pickup manner in the pickup manner selection area. Compared with the way the first virtual character picks up the first virtual prop based on the default pickup rule, it can be avoided that the first virtual character performs an unnecessary equipping or deployment operation during pickup of the first virtual prop. This not only can effectively reduce several times a system responds to user operations and improve system resource utilization, but also can improve degrees of freedom and flexibility of operations of a player. Besides, this can avoid time consumption caused when the player re-adjusts the prop because the default pickup rule does not conform to a manner preferred by the player, and can improve human computer interaction efficiency.

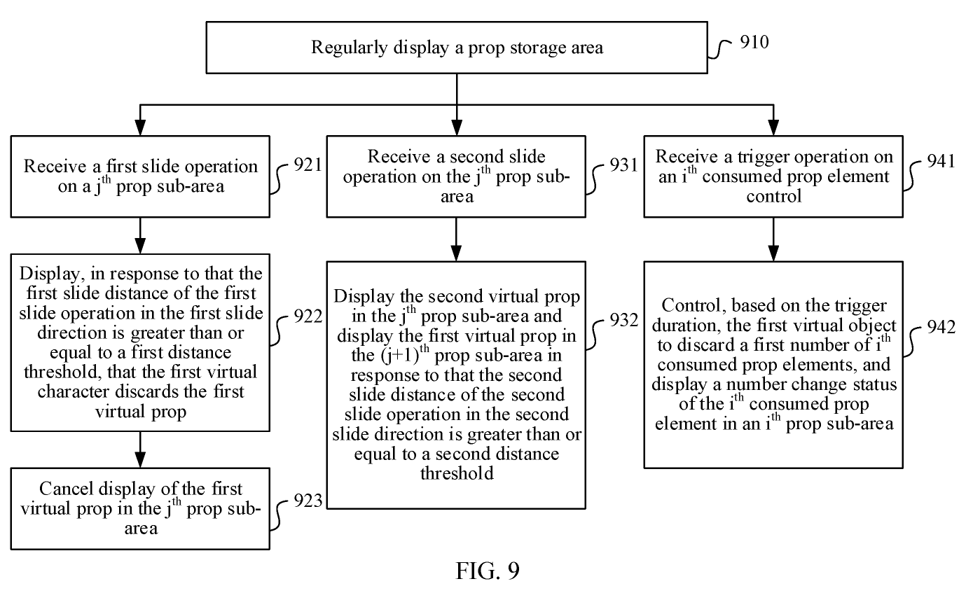

After the first virtual character picks up the virtual prop, the virtual prop owned by the first virtual character can be stored in the prop equipping area that is regularly displayed. A player may also control, by using a prop management function provided by the prop equipping area, a storage manner of the virtual prop, whether to discard the virtual prop, or the like. As shown in FIG. 9, FIG. 9 is a flowchart of a virtual prop control method according to another exemplary embodiment of this application. The method includes the following operations:

Operation 910: Regularly display a prop equipping area.

The prop equipping area is used to display a virtual prop owned by the first virtual character. The prop equipping area includes multiple prop sub-areas, an i^{th} prop sub-area corresponds to an i^{th} prop sequence slot in the pickup manner selection area, and i is a positive integer.

For example, the prop identifier of the first virtual prop exists in a j^{th} prop sequence slot in the pickup manner selection area. In this case, a j^{th} prop sub-area is used to store and display the first virtual prop.

The prop equipping area is regularly displayed, so that when controlling a virtual character to perform a virtual battle, a player can know a specific type and a specific storage location of a prop of the virtual character at any time. Compared with a way the player opens a storage backpack interface to view a prop status, redundant operations can be avoided, and human computer interaction efficiency can be improved.

Operation 921: Receive a first slide operation starting from a j^{th} prop sub-area.

The first slide operation corresponds to a first slide direction and a first slide distance, and the first slide direction and the first slide distance are determined based on a start slide location of the first slide operation in the j^{th} prop sub-area.

The first slide distance is a slide distance of the first slide operation in the first slide direction, and a slide start point of the first slide operation is located within a range of the j^{th} prop sub-area.

Operation 922: Display, in response to that the first slide distance of the first slide operation in the first slide direction is greater than or equal to a first distance threshold, that the first virtual character discards the first virtual prop. In other words, the computer device causes the first virtual character to discard the first virtual prop.

Exemplarily, the first distance threshold is 2 distance units, the first slide direction is an upward direction, an opposite direction of the first slide direction is a downward direction, and a slide process corresponding to the first slide operation is as follows: sliding in the upward direction by 5 distance units, sliding in the downward direction by 4 distance units, then sliding in the upward direction by 2 distance units, and ending the slide.

Therefore, the first slide distance is: 5–4+2=3 units, and is greater than the first distance threshold. That the first virtual character discards the first virtual prop is displayed.

Operation 923: Cancel display of the first virtual prop in the j^{th} prop sub-area.

After the first virtual prop is discarded by the first virtual character, a virtual prop owned by the first virtual character no longer includes the first virtual prop.

A location in which the first virtual prop is discarded by the first virtual character may be any location in the virtual scene, for example, a current location of the first virtual character. In this case, the first virtual prop may still be picked up by another virtual character. Alternatively, in some embodiments, the first slide operation is an accidental touch operation, and the player may control the first virtual character to pick up the first virtual prop again.

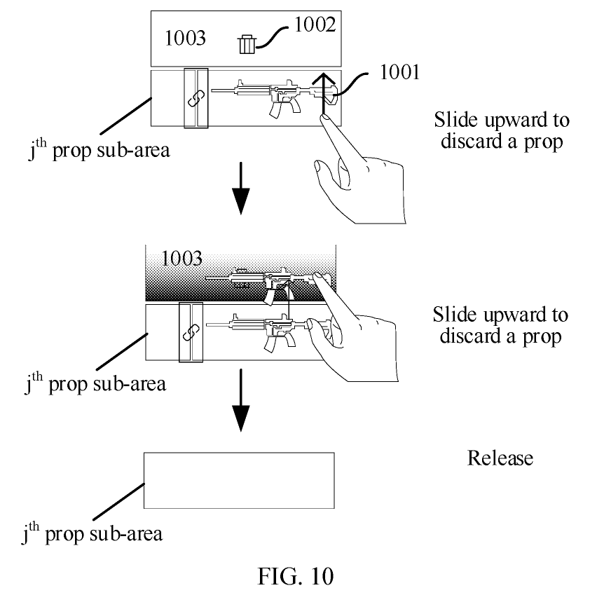

Exemplarily, as shown in FIG. 10, FIG. 10 is a schematic diagram of discarding a first virtual prop based on a first slide operation.

A first slide operation of a player on a first virtual prop 1001 in the j^{th} prop sub-area is received, and a prop discarding identifier 1002 is displayed when the player slides in the first slide direction. The prop discarding identifier 1002 corresponds to a prop discarding hot zone 1003. The prop discarding identifier 1002 is used to prompt the player to end the first slide operation in the prop discarding hot zone 1003, to discard the first virtual prop 1001.

A slide operation is performed in the prop equipping area regularly displayed, to control a virtual character to directly discard a virtual prop, so that the operation process is simple and intuitive. Compared with the related art in which a player needs to switch an interface of the prop storage backpack and an interface of a virtual battle back and forth to control a virtual character to discard a virtual prop, human computer interaction efficiency can be improved.

Operation 931: Receive a second slide operation starting from the j^{th} prop sub-area.

A second virtual prop is displayed in a (j+1)^{th} prop sub-area of the prop equipping area, and the j^{th} prop sub-area is adjacent to the (j+1)^{th} prop sub-area.

The second slide operation corresponds to a second slide direction and a second slide distance, the second slide direction points from the j^{th} prop sub-area to the (j+1)^{th} prop sub-area, and the second slide direction and the second slide distance are determined based on a start slide location of the second slide operation in the j^{th} prop sub-area.

The second slide distance is a slide distance of the second slide operation in the second slide direction, and a slide start point of the second slide operation is located within a range of the j^{th} prop sub-area.

Operation 932: Display the second virtual prop in the j^{th} prop sub-area and display the first virtual prop in the (j+1)^{th} prop sub-area in response to that the second slide distance of the second slide operation in the second slide direction is greater than or equal to a second distance threshold.

Exemplarily, the prop equipping area includes 2 prop sub-areas, the second slide direction is a horizontal direction (including a horizontal leftward direction or a horizontal rightward direction), the second distance threshold is a width of the j^{th} prop sub-area, and the width of the j^{th} prop sub-area is set to 3 distance units.

Exemplarily, if the j^{th} prop sub-area is located on the left of the (j+1)^{th} prop sub-area, the second slide direction is the horizontal rightward direction, and if the j^{th} prop sub-area is located on the right of the (j+1)^{th} prop sub-area, the second slide direction is the horizontal leftward direction. The second slide distance is 3.5 distance units and reaches the second distance threshold, and virtual props displayed in the j^{th} prop sub-area and the (j+1)^{th} prop sub-area are exchanged.

In some embodiments, in response to that a slide end point of the second slide operation is within a range of the (j+1)^{th} prop sub-area, the second virtual prop is displayed in the j^{th} prop sub-area, and the first virtual prop is displayed in the (j+1)^{th} prop sub-area.

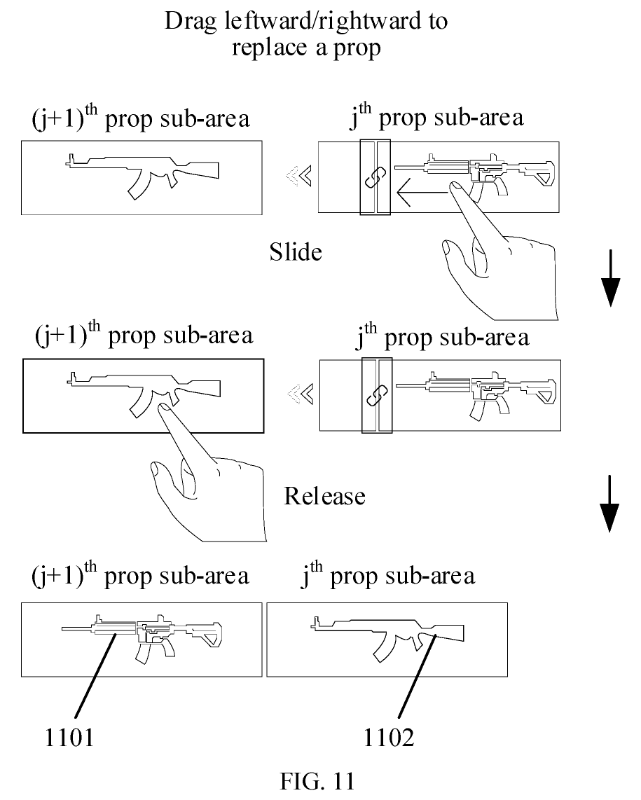

Exemplarily, as shown in FIG. 11, FIG. 11 is a schematic diagram of exchanging virtual props in different prop sub-areas in display based on a second slide operation.

A first virtual prop 1101 is displayed in the j^{th} prop sub-area, and a second virtual prop 1102 is displayed in the (j+1)^{th} prop sub-area. A second slide operation on the first virtual prop 1101 in the j^{th} prop sub-area by a player is received. When the player slides into the (j+1)^{th} prop sub-area, the (j+1)^{th} prop sub-area is highlighted to prompt the player to end the second slide operation, and virtual props displayed in the j^{th} prop sub-area and the (j+1)^{th} prop sub-area are exchanged in display.

A slide operation is performed in the prop equipping area regularly displayed, to exchange locations of virtual props stored in different locations, so that human computer interaction efficiency can be improved.

Operation 941: Receive a trigger operation on an i^{th} consumed prop element control.

The trigger operation corresponds to a trigger duration, and the trigger duration is used to determine a number of i^{th} consumed prop elements that are discarded. That is, the i^{th} consumed prop element control can be triggered to correspond to the i^{th} consumed prop element.

Operation 942: Control, based on the trigger duration, the first virtual object to discard a first number of i^{th} consumed prop elements, and display a number change status of the i^{th} consumed prop element in an i^{th} prop sub-area.

In an embodiment, the trigger duration corresponds to a duration threshold. When the trigger duration is less than the duration threshold and greater than zero, a preset number of i^{th} consumed prop elements are discarded. When the trigger duration is greater than the duration threshold, all the i^{th} consumed prop elements are discarded.

Exemplarily, the duration threshold is 0.5 second and the preset number is 30. When the player triggers and immediately releases the i^{th} consumed prop element control, the trigger duration is 0.1 second and is less than the duration threshold, and 30 i^{th} consumed prop elements are discarded.

Exemplarily, the duration threshold is 0.5 second. When the player triggers and does not immediately release the i^{th} consumed prop element control, a progress bar corresponding to the trigger duration is displayed. The trigger duration is in positive correlation with a brightness bar of the progress bar. When the trigger duration reaches the duration threshold, the length of the brightness bar of the progress bar is the highest, and all the i^{th} consumed prop elements are discarded.

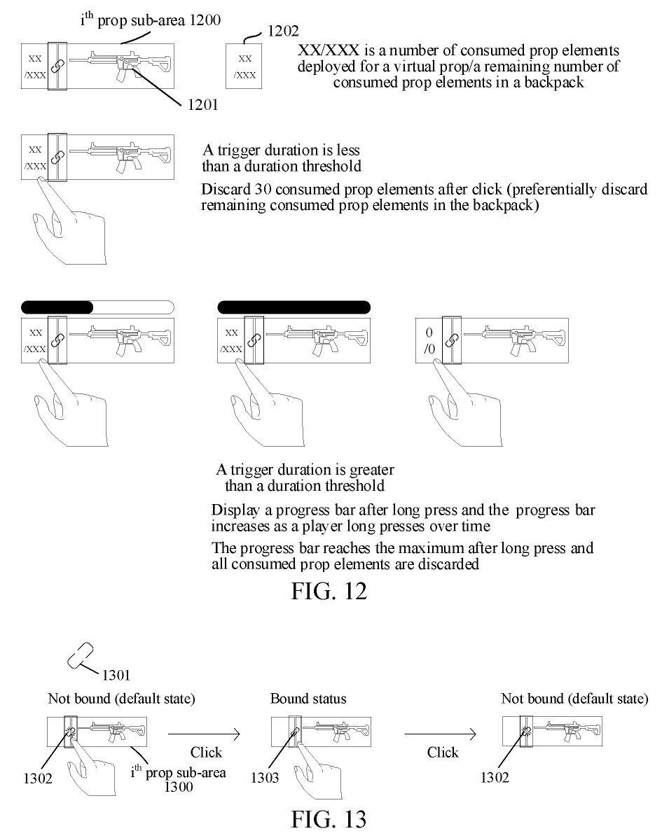

Exemplarily, as shown in FIG. 12, an i^{th} consumed prop element is a virtual element that needs to be consumed when a virtual prop 1201 in an i^{th} prop sub-area 1200 implements a prop function. An i^{th} consumed prop element control 1202 and a remaining number of i^{th} consumed prop elements are displayed in the i^{th} prop sub-area 1200.

Each time the i^{th} consumed prop element control 1202 is triggered (a trigger duration is less than a duration threshold), a preset number (for example, 30) of i^{th} consumed prop elements are discarded. When the duration of triggering the i^{th} consumed prop element control 1202 reaches a duration threshold, all the i^{th} consumed prop elements are discarded.

After the i^{th} consumed prop element is discarded, a corresponding number change status is displayed in the i^{th} prop sub-area 1200.

In some embodiments, if a remaining number of i^{th} consumed prop elements is less than a preset number, after the i^{th} consumed prop element control is triggered again, all the i^{th} consumed prop elements are discarded.

In some embodiments, when a binding relationship is established between the i^{th} consumed prop element and the i^{th} virtual prop, a third slide operation on the i^{th} virtual prop is received. The third slide operation corresponds to the first slide direction and the third slide distance. In response to that the third slide distance of the third slide operation in the first slide direction is greater than or equal to the first distance threshold, that the first virtual character discards the i^{th} virtual prop and multiple i^{th} consumed prop elements is displayed, and that a number of i^{th} consumed prop elements is zero in the i^{th} prop sub-area is displayed.

Exemplarily, as shown in FIG. 13, an i^{th} prop sub-area 1300 includes a binding control 1301, a trigger operation on the binding control 1301 is received, and a binding relationship between an i^{th} consumed prop element and an i^{th} virtual prop is established.

At an initial moment, that is, when the player has not triggered the binding control 1301, the binding relationship between the i^{th} consumed prop element and the i^{th} virtual prop is not established by default, and the binding control 1301 is displayed in a fifth display manner 1302. In this case, the binding control 1301 is triggered, to establish a binding relationship between the i^{th} consumed prop element and the i^{th} virtual prop, and the binding control 1301 is displayed in a sixth display manner 1303. The binding control 1301 is triggered again, the binding relationship between the i^{th} consumed prop element and the i^{th} virtual prop is released, and the binding control 1301 is displayed in the fifth display manner 1302 again.

That is, each time the binding control 1301 is triggered, the binding relationship between the i^{th} consumed prop element and the i^{th} virtual prop is changed.

Exemplarily, a difference between the fifth display manner 1302 and the sixth display manner 1303 lies in display brightness. Display brightness corresponding to the fifth display manner 1302 is lower than display brightness corresponding to the sixth display manner 1303.

When a virtual prop or a consumed prop element is discarded based on the binding relationship between the i^{th} virtual prop and multiple i^{th} consumed prop elements, the following several cases are included.

1. The binding relationship is not established between the i^{th} virtual prop and multiple i^{th} consumed prop elements.

1.1. The i^{th} virtual prop is not discarded when the i^{th} consumed prop element is discarded.

1.2. The i^{th} consumed prop element is not discarded when the i^{th} virtual prop is discarded.

2. The binding relationship is established between the i^{th} virtual prop and multiple i^{th} consumed prop elements.

2.1. When the i^{th} consumed prop element is discarded, the i^{th} virtual prop is not discarded, but no matter how many times the operation of discarding the i^{th} consumed prop element is triggered, a preset number of i^{th} consumed prop elements are reserved for deploying the i^{th} virtual prop.

For example, the first virtual character has 100 i^{th} consumed prop elements, and the i^{th} virtual prop can be equipped with 30 i^{th} consumed prop elements each time. In this case, when the i^{th} consumed prop elements are discarded multiple times, 30 i^{th} consumed prop elements are still reserved.

2.2. All i^{th} consumed prop elements are simultaneously discarded when the i^{th} virtual prop is discarded.

An operation type of establishing the binding relationship between the i^{th} consumed prop element and the i^{th} virtual prop may be any type, and the fifth display manner and the sixth display manner may be any different display manners.

The consumed prop element is used to implement a prop function of the virtual prop, and the consumed prop element can function only when the virtual character uses the virtual prop. Therefore, by establishing the binding relationship between the virtual prop and the consumed prop element, the consumed prop element that implements the prop function can also be discarded when the virtual prop is discarded. Compared with separate discarding of the virtual prop and the consumed prop element, operation operations can be simplified, and human computer interaction efficiency can be improved.

Content performed in operation 921 to operation 923, content performed in operation 931 and operation 932, and content performed in operation 941 and operation 942 are in parallel, and respectively represent three different operation types. Operation 921 to operation 923 correspond to an operation type of discarding the virtual prop, operation 931 and operation 932 correspond to an operation type of exchanging storage locations of the virtual props, and operation 941 and operation 942 correspond to an operation type of establishing a binding relationship between the virtual prop and the consumed prop element. A sequence of performing the foregoing operations may be any sequence and is not limited in this embodiment.

In conclusion, in the method provided in this embodiment, the first virtual character and the first virtual prop in the virtual scene are displayed, and the corresponding pickup manner selection area of the first virtual prop is displayed when the first virtual character and the first virtual prop satisfy the prop pickup requirement. The pickup manner selection area can provide the first virtual character with a pickup manner option of picking up the first virtual prop. Setting information such as the equipping manner of the picked-up first virtual prop and the deployment manner of the consumed prop element during pickup of the first virtual prop is determined, so that the first virtual character immediately determines how to control/use the first virtual prop when obtaining the first virtual prop. That the first virtual character picks up the first virtual prop based on the first pickup manner is displayed in response to the trigger operation on the first pickup manner in the pickup manner selection area. Compared with the way the first virtual character picks up the first virtual prop based on the default pickup rule, it can be avoided that the first virtual character performs an unnecessary equipping or deployment operation during pickup of the first virtual prop. This can improve degrees of freedom and flexibility of operations of a player. Besides, this can avoid time consumption caused when the player re-adjusts the prop because the default pickup rule does not conform to a manner preferred by the player, and can improve human computer interaction efficiency.

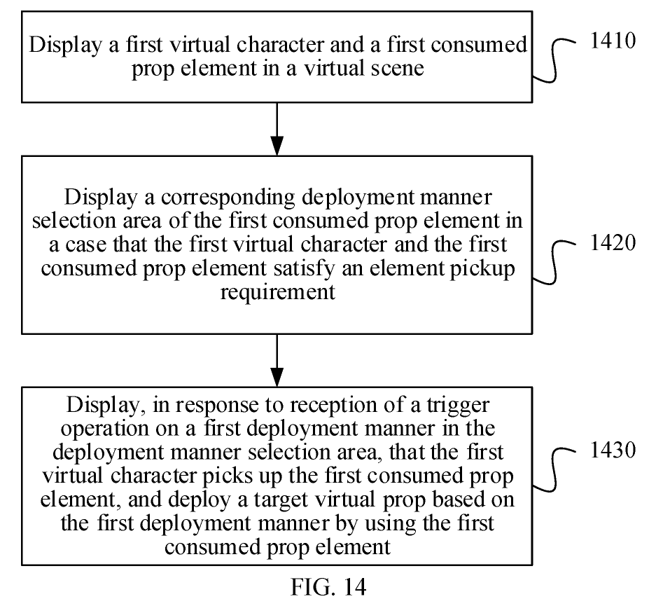

In some embodiments, in addition to the virtual prop, a consumed prop element also randomly appears in the virtual scene, and the virtual character may pick up the consumed prop element in the virtual scene to deploy an owned virtual prop. When the virtual character and the consumed prop element satisfy an element pickup requirement, a pickup manner of picking up the consumed prop element by the virtual character may also be set. As shown in FIG. 14, FIG. 14 is a flowchart of a virtual element control method according to an exemplary embodiment of this application. The method includes the following operations.

Operation 1410: Display a first virtual character and a first consumed prop element in a virtual scene.

That is, in addition to the virtual character and the virtual prop, the virtual scene further includes consumed prop elements, and the consumed prop elements include the first consumed prop element.

In an embodiment, a game system randomly grants a consumed prop element in a virtual scene to be obtained by a virtual character of a player. A location of the consumed prop element in the virtual scene is any location. Alternatively, another player account may discard an owned consumed prop element in the virtual scene.

Exemplarily, the first consumed prop element is a consumed prop element randomly appearing in the virtual scene, and the first player account may control the first virtual character to pick up the first consumed prop element.

Exemplarily, the first consumed prop element corresponds to a virtual shooting prop, and is a virtual element consumed when the virtual shooting prop implements a shooting prop function. That is, when the first virtual character performs a virtual battle with another virtual character by using the virtual shooting prop, the first virtual character needs to deploy the virtual shooting prop with the first consumed prop element in advance, to attack the another virtual character.

Operation 1420: Display a corresponding deployment manner selection area of the first consumed prop element when the first virtual character and the first consumed prop element satisfy an element pickup requirement.

The deployment manner selection area is used for providing the first virtual character with a deployment manner of a matching virtual prop during pickup of the first consumed prop element, and the matching virtual prop is a virtual prop that is owned by the first virtual character and that needs to consume the first consumed prop element to implement a prop function.

Exemplarily, the first virtual character has the first virtual prop, and there is a matching relationship between the first virtual prop and the first consumed prop element. That is, the first virtual prop needs to consume the first consumed prop element to implement a prop function.

In an embodiment, the element pickup requirement of the virtual character and the consumed prop element is as follows: a distance between the virtual character and the consumed prop element is less than or equal to a preset distance threshold.

For example, the preset distance threshold is 3 distance units, and the distance between the first virtual character and the first consumed prop element is 2 distance units. This distance is less than the preset distance threshold, and the element pickup requirement is satisfied.

In an embodiment, the deployment manner of the matching virtual prop includes but is not limited to: (1) whether to automatically deploy the matching virtual prop; (2) when automatically deploying the matching virtual prop, and there are multiple matching virtual props, determining a target virtual prop in the multiple matching virtual props to perform automatic deployment; and (3) whether to automatically establish a binding relationship between the matching virtual prop and the first consumed prop element.

Operation 1430: Display, in response to a trigger operation on a first deployment manner in the deployment manner selection area, that the first virtual character picks up the first consumed prop element, and deploy a target virtual prop based on the first deployment manner by using the first consumed prop element. In other words, the computer device causes the first virtual character to pick up the first consumed prop element based on the first pickup manner and then deploys a target virtual prop based on the first deployment manner by using the first consumed prop element.

In an embodiment, in response to a selection operation on a k^{th} matching virtual prop in the deployment manner selection area, that the first virtual character picks up the first consumed prop element is displayed, and the k^{th} matching virtual prop is deployed by using the first consumed prop element.

In an embodiment, in response to a trigger operation on a deployment cancellation control in the deployment manner selection area, that the first virtual character picks up the first consumed prop element is displayed, and deployment of the k^{th} matching virtual prop by using the first consumed prop element is canceled.

Exemplarily, a matching virtual prop list is displayed in the deployment manner selection area, a virtual prop displayed in the matching virtual prop list needs to consume the first consumed prop element when implementing a prop function, and the matching virtual prop list includes a first virtual prop and a second virtual prop.

A function of automatically deploying a matching virtual prop is disabled in a default state. If the player selects the first virtual prop, when picking up the first consumed prop element, the first virtual character automatically deploys the first virtual prop by using the first consumed prop element. If the player selects the first virtual prop and the second virtual prop at the same time, when picking up the first consumed prop element, the first virtual character automatically deploys the first virtual prop and the second virtual prop by using the first consumed prop element. A deployment sequence may be any sequence.

The deployment manner selection area includes the deployment cancellation control. If the player intends to cancel automatic deployment after selecting the matching virtual prop, this may be implemented by triggering the deployment cancellation control. In some embodiments, the selected matching virtual prop may also be triggered again, to cancel automatic deployment.

In some embodiments, the deployment manner selection area further includes a binding control separately corresponding to each matching virtual prop in the matching virtual prop list, and the binding control is used to establish a binding relationship between the first consumed prop element and the matching virtual prop.

Exemplarily, an example of a k^{th} binding control corresponding to a k^{th} matching virtual prop is used, where k is a positive integer.

At an initial moment, that is, when the player has not triggered the k^{th} binding control, the binding relationship between the first consumed prop element and the k^{th} matching virtual prop is not established by default. In this case, the k^{th} binding control is triggered, so that the binding relationship between the first consumed prop element and the k^{th} matching virtual prop is established. If the k^{th} binding control is triggered again, the binding relationship between the first consumed prop element and the k^{th} matching virtual prop is released.

That is, each time the k^{th} binding control is triggered, the binding relationship between the first consumed prop element and the k^{th} matching virtual prop is changed.

In conclusion, in the method provided in this embodiment, when the virtual character and the consumed prop element in the virtual scene satisfy the element pickup requirement, the deployment manner selection area of the consumed prop element is displayed, to provide a deployment option of a pickup manner in which a player controls the virtual character to pick up the consumed prop element. In this way, when obtaining the consumed prop element, the virtual character immediately determines how to control/use the consumed prop element. This can improve degrees of freedom and flexibility of operation of a player. Besides, this can avoid time consumption caused when the player re-adjusts the element because the default pickup rule does not conform to a manner preferred by the player, and can improve human computer interaction efficiency.

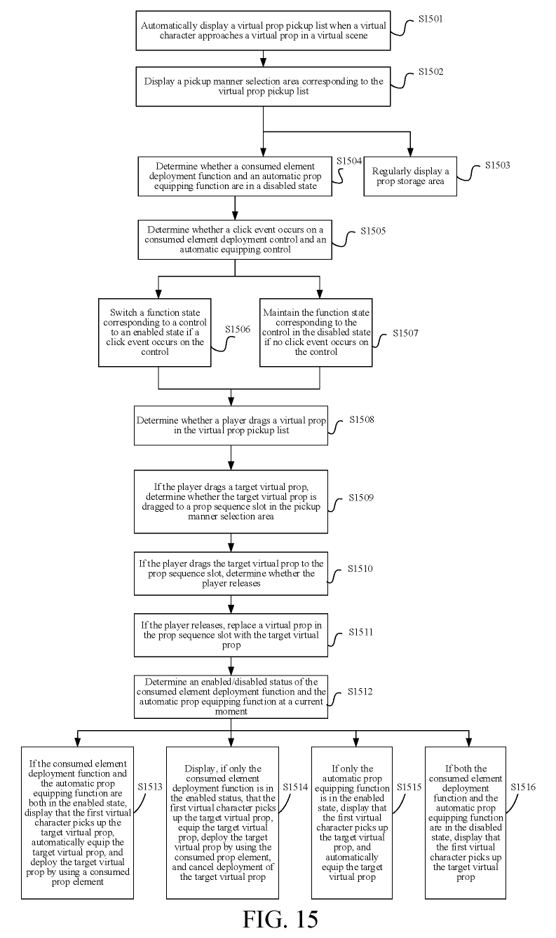

FIG. 15 is a flowchart of an operation based on a pickup manner selection area according to an exemplary embodiment of this application. The method is performed by a terminal.

In a virtual scene, a virtual character is controlled by a player by using a terminal. For example, a virtual prop is a virtual shooting prop, and a consumed prop element is a virtual bullet element. A virtual scene displayed on a terminal screen includes a virtual character and a virtual prop to be picked up.

S1501: Automatically display a virtual prop pickup list when a virtual character approaches a virtual prop in a virtual scene.

The virtual prop pickup list includes at least one virtual prop that satisfies a prop pickup requirement together with the first virtual character. That is, the first virtual character may pick up a virtual prop in the virtual prop pickup list.

Exemplarily, the virtual prop pickup list includes: a virtual shooting prop A, a virtual shooting prop B, and a virtual shooting prop C. Shooting types of the virtual props are different.

S1502: Display a pickup manner selection area corresponding to the virtual prop pickup list.

The pickup manner selection area includes a consumed element deployment control, an automatic equipping control, and multiple prop sequence slots.

The multiple prop sequence slots are used to indicate a location of a picked-up virtual prop in a storage backpack of the first virtual character after the first virtual character picks up the virtual prop, and an equipping sequence of using the virtual prop by the first virtual character.

Exemplarily, the first virtual character has a consumed prop element matching the virtual shooting prop A, that is, a virtual bullet element A.

After the consumed element deployment control is triggered, if the player controls the first virtual character to pick up the virtual shooting prop A, the virtual shooting prop A is automatically deployed by using the virtual bullet element A during pickup.

Exemplarily, after the automatic equipping control is triggered, if the player controls the first virtual character to pick up the virtual shooting prop A, the first virtual character automatically performs an action of pulling a gun (that is, an action of pulling the virtual shooting prop A from the backpack) after picking up the virtual shooting prop A.

Exemplarily, the prop sequence slot includes a primary prop slot and a secondary prop slot, and there is a correspondence between an equipping action and a prop sequence slot of the virtual shooting prop A.

For example, if the virtual shooting prop A is dragged to the primary prop slot and a player triggers an automatic equipping control, the first virtual character pulls the virtual shooting prop A from the front of the character. If the virtual shooting prop A is dragged to the secondary prop slot, the first virtual character pulls the virtual shooting prop A from behind the character.

S1503: Regularly display a prop equipping area.

The prop equipping area includes multiple prop sub-areas, and there is a correspondence between a prop sub-area and a prop sequence slot in the pickup manner selection area.

That is, an i^{th} prop sub-area corresponds to an i^{th} prop sequence slot, where i is a positive integer.

A virtual prop dragged to the i^{th} prop sequence slot is displayed in the i^{th} prop sub-area after being picked up by the first virtual character, to regularly prompt a player of a storage location of the virtual prop.

S1504: Determine whether a consumed element deployment function and an automatic prop equipping function are in a disabled state.

In a default state, the two functions are both in the disabled state.

S1505: Determine whether a click event occurs on a consumed element deployment control and an automatic equipping control.

The click event refers to whether a player clicks on a control. If the player triggers the control, it indicates that there is a click event.

S1506: Switch a function state corresponding to a control to an enabled state if a click event occurs on the control.

Enabling and disabling of the consumed element deployment function and the automatic prop equipping function are independently set, and an enabled/disabled state of one function and an enabled/disabled state of the other function do not affect each other.

S1507: Maintain the function state corresponding to the control in the disabled state if no click event occurs on the control.

In some embodiments, whether the control is in the disabled state may be determined according to a display manner of the control. A display manner of the control in the enabled state is different from a display manner of the control in the disabled state.

If no click event occurs on the control, a display manner of the control does not change.

S1508: Determine whether a player drags a virtual prop in the virtual prop pickup list.

The player drags the virtual prop to the prop sequence slot of the pickup manner selection area, to determine a storage manner and a location of the virtual prop.

For example, if the player drags the virtual shooting prop A in the virtual prop pickup list to a first prop sequence slot, after the first virtual character picks up the virtual shooting prop A, the virtual shooting prop A is correspondingly displayed in the first prop sub-area in the prop equipping area.

S1509: If the player drags a target virtual prop, determine whether the target virtual prop is dragged to a prop sequence slot in the pickup manner selection area.

The target virtual prop is a virtual prop selected by the player from the virtual prop pickup list and dragged by the player.

For example, if the player drags the virtual shooting prop A in the virtual prop pickup list, the virtual shooting prop A is the target virtual prop.

S1510: If the player drags the target virtual prop to the prop sequence slot, determine whether the player releases.

A location in which the player releases is a storage location of the target virtual prop in the prop equipping area.

S1511: If the player releases, replace a virtual prop in the prop sequence slot with the target virtual prop.

Exemplarily, a virtual prop C is originally displayed in a prop sequence slot 1, and the player drags the virtual shooting prop A in the virtual prop pickup list to the prop sequence slot 1. In this case, the virtual shooting prop A is displayed in the prop sequence slot 1, and the original virtual prop C is discarded by the first virtual character.

S1512: Determine an enabled/disabled state of the consumed element deployment function and the automatic prop equipping function at a current moment.

The enabled/disabled states of the two functions are respectively determined according to display manners of the consumed element deployment control and the automatic equipping control.

S1513: If the consumed element deployment function and the automatic prop equipping function are both in the enabled state, display that the first virtual character picks up the target virtual prop, automatically equip the target virtual prop, and deploy the target virtual prop by using a consumed prop element.

For example, after picking up the virtual shooting prop A, the first virtual character automatically performs an action of pulling a gun, and deploys the virtual shooting prop A by using the virtual bullet element A (that is, performs a bullet reload action). After the deployment, the first virtual character maintains an action status in which the virtual shooting prop A has been pulled.

S1514: Display, if only the consumed element deployment function is in the enabled status, that the first virtual character picks up the target virtual prop, equip the target virtual prop, deploy the target virtual prop by using the consumed prop element, and cancel deployment of the target virtual prop.

For example, after picking up the virtual shooting prop A, the first virtual character automatically performs an action of pulling a gun, and deploys the virtual shooting prop A by using the virtual bullet element A (that is, performs a bullet reload action). After the deployment, the first virtual character returns the virtual shooting prop A to the prop storage backpack.

S1515: If only the automatic prop equipping function is in the enabled state, display that the first virtual character picks up the target virtual prop, and automatically equip the target virtual prop.

For example, after picking up the virtual shooting prop A, the first virtual character automatically performs an action of pulling a gun and maintains an action state in which the virtual shooting prop A has been pulled.

S1516: If both the consumed element deployment function and the automatic prop equipping function are in the disabled state, display that the first virtual character picks up the target virtual prop.

For example, after picking up the virtual shooting prop A, the first virtual character directly stores the virtual shooting prop A in the prop storage backpack.

In conclusion, in the method provided in this embodiment, multiple operation types of performing an operation based on the pickup manner selection area are listed, so that when a player controls a virtual character to pick up a virtual prop, a manner of equipping or deploying the virtual prop can be immediately determined, thereby improving human computer interaction efficiency.

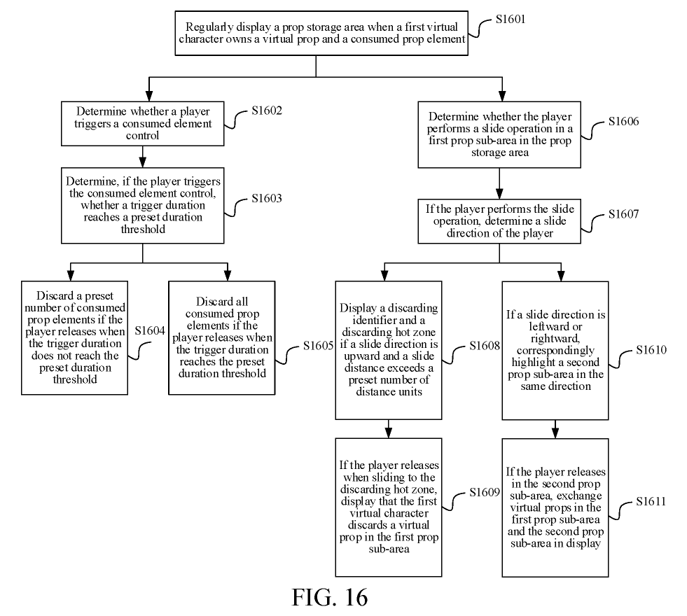

FIG. 16 is a flowchart of an operation based on a prop equipping area according to an exemplary embodiment of this application. The method is performed by a terminal.

S1601: Regularly display a prop equipping area when a first virtual character owns a virtual prop and a consumed prop element.

The prop equipping area includes multiple prop sub-areas, used to indicate storage locations and sequences of virtual props owned by the first virtual character.

For example, the prop equipping area includes a first prop sub-area and a second prop sub-area that respectively store a virtual shooting prop A and a virtual shooting prop B.

S1602: Determine whether a player triggers a consumed element control.

If the first virtual character owns consumed prop elements, each time the consumed element control is triggered, the first virtual character is controlled to discard several consumed prop elements.

Each virtual prop corresponds to a consumed element control.

Exemplarily, the virtual shooting prop A corresponds to a first consumed element control, the virtual shooting prop A matches the consumed prop element A, and several consumed prop elements A is 100.

For example, the player triggers the first consumed element control once and immediately releases, and the terminal displays that the first virtual character discards 30 consumed prop elements A.

S1603: Determine, when the player triggers the consumed element control, whether a trigger duration reaches a preset duration threshold.

The trigger duration is a duration from a time at which the player triggers the consumed element control to a time at which the player releases.

S1604: Discard a preset number of consumed prop elements if the player releases when the trigger duration does not reach the preset duration threshold.

For example, if the duration threshold is 0.5 second and the player releases when 0.5 second is not reached, 30 consumed prop elements are discarded.

S1605: Discard all consumed prop elements if the player releases when the trigger duration reaches the preset duration threshold.

For example, if the duration threshold is 0.5 second and the player releases when the trigger duration is 0.6 second, all consumed prop elements are discarded.

S1606: Determine whether the player performs a slide operation in a first prop sub-area in the prop equipping area.

It is determined whether a finger of the player triggers the first prop sub-area and continues to move on the terminal screen.

S1607: If the player performs the slide operation, determine a slide direction of the player.

Different slide directions correspond to different operation results.

S1608: Display a discarding identifier and a discarding hot zone if a slide direction is upward and a slide distance exceeds a preset number of distance units.

The discarding identifier is used to instruct the player to slide to the discarding hot zone and release, thereby discarding the virtual prop.

S1609: If the player releases when sliding to the discarding hot zone, display that the first virtual character discards a virtual prop in the first prop sub-area.

If the first virtual character deploys, before discarding the virtual prop, the virtual prop by using the consumed prop element, after the virtual prop is discarded, that the first virtual character returns the consumed prop element corresponding to the virtual prop to the storage backpack continues to be displayed.

S1610: If a slide direction is leftward or rightward, correspondingly highlight a second prop sub-area in the same direction.

The second prop sub-area is highlighted, to instruct the finger of the player to move from a range of the first prop sub-area to a range of the second prop sub-area.

S1611: If the player releases in the second prop sub-area, exchange virtual props in the first prop sub-area and the second prop sub-area in display.

For example, before the player releases, the virtual shooting prop A is displayed in the first prop sub-area, and a virtual shooting prop B is displayed in the second prop sub-area. The player performs a slide operation, and the finger of the player moves from the range of the first prop sub-area to the range of the second prop sub-area and the player releases. In this case, after the player releases, the virtual shooting prop B is displayed in the first prop sub-area, and the virtual shooting prop A is displayed in the second prop sub-area.

In conclusion, in the method provided in this embodiment, multiple operation types for performing an operation based on the prop equipping area are listed, so that a process of adjusting a virtual prop in the prop equipping area can be simplified, and human computer interaction efficiency can be improved.

FIG. 17 is a flowchart of controlling a consumed prop element and a virtual prop based on a prop equipping area according to an exemplary embodiment of this application. The method is performed by a terminal.

S1701: Display a first virtual prop and a corresponding first consumed prop element in a prop equipping area after a first virtual character picks up the first virtual prop.

For example, the prop equipping area includes multiple prop sub-areas, and a prop identifier of the first virtual prop and an element number of first consumed prop elements are displayed in a first prop sub-area.

S1702: Determine that a binding relationship is not currently established between the first consumed prop element and the first virtual prop.

In a default state, there is no binding relationship between the first consumed prop element and the first virtual prop, that is, the player controls the first consumed prop element and the first virtual prop independently.

S1703: Determine whether a player triggers a binding control of the prop equipping area.

The binding control is used to establish a binding relationship between the first consumed prop element and the first virtual prop.

S1704: If the player triggers the binding control, establish a binding relationship between the first consumed prop element and the first virtual prop.

A display manner of the binding control before the binding relationship between the first consumed prop element and the first virtual prop is established is different from a display manner of the binding control after the binding relationship is established.

S1705: If the player triggers a consumed prop element control corresponding to the first consumed prop element, display, based on a trigger duration, that the first virtual character discards some first consumed prop elements.

Some first consumed prop elements are reserved for deploying the first virtual prop.

For example, the first virtual prop is a virtual shooting prop, the first consumed prop element is a matching bullet element, and a magazine of the virtual shooting prop can store 30 bullet elements. Therefore, even if the first consumed prop elements are discarded multiple times, 30 bullet elements are reserved.

S1706: If the player selects the first virtual prop and slides upward, display that the first virtual character discards the first virtual prop and all first consumed prop elements.

The operation that the player selects the first virtual prop and slides upward is used to control the first virtual character to discard the first virtual prop. A binding relationship is established between the first virtual prop and the first consumed prop element. Therefore, when the first virtual character discards the first virtual prop, the first consumed prop element matching the first virtual prop is simultaneously discarded according to the binding relationship.

In conclusion, in the method provided in this embodiment, several operation types of separate control and joint control of a consumed prop element and a virtual prop based on the prop equipping area are listed. A binding relationship between a consumed prop element and a virtual prop can be established, so that only one operation is needed to implement simultaneous control of a prop and an element, thereby improving human computer interaction efficiency.

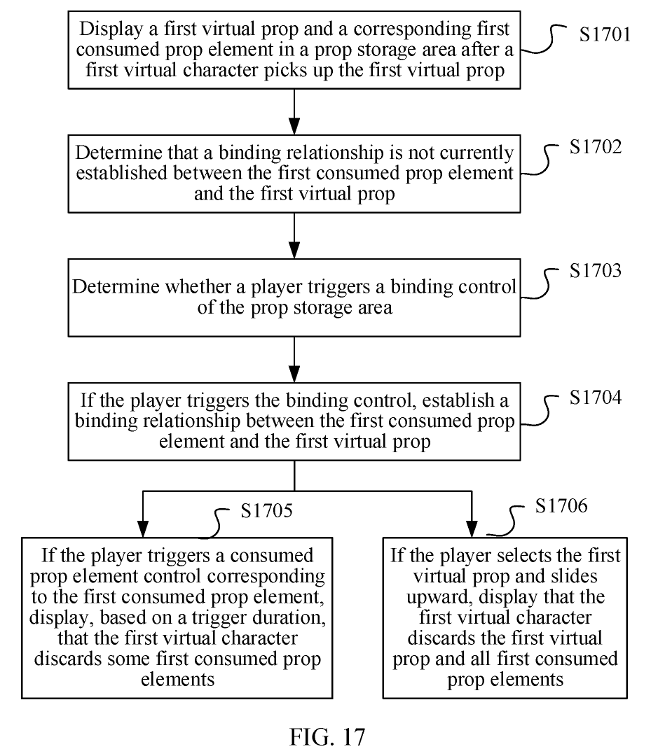

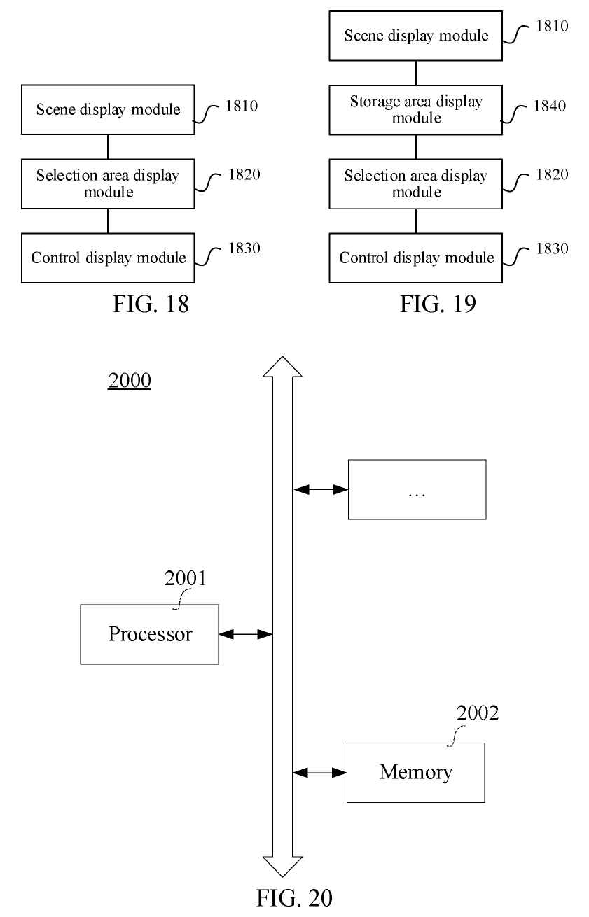

FIG. 18 is a structural block diagram of a virtual prop control apparatus according to an exemplary embodiment of this application. As shown in FIG. 18, the apparatus includes:

a scene display module 1810, configured to display a first virtual character and a first virtual prop in a virtual scene;

a selection area display module 1820, configured to display a corresponding pickup manner selection area of the first virtual prop when the first virtual character and the first virtual prop satisfy a prop pickup requirement, the pickup manner selection area being used for providing the first virtual character with a pickup manner of picking up the first virtual prop, the pickup manner including at least one of an equipping manner of the picked-up first virtual prop and a deployment manner of a consumed prop element during pickup of the first virtual prop, and the consumed prop element being a virtual element consumed when the first virtual prop implements a prop function; and

a control display module 1830, configured to display, in response to a trigger operation on a first pickup manner in the pickup manner selection area, that the first virtual character picks up the first virtual prop based on the first pickup manner.

In an embodiment, the control display module 1830 is further configured to: display, in response to a consumed element deployment operation in the pickup manner selection area, that the first virtual character picks up the first virtual prop, and deploy the first virtual prop based on the consumed prop element.

In an embodiment, the control display module 1830 is further configured to display, in response to an automatic prop equipping operation in the pickup manner selection area, that the first virtual character picks up the first virtual prop, and automatically equip the first virtual prop.

In an embodiment, the pickup manner selection area includes multiple prop sequence slots, the multiple prop sequence slots correspond to different sequence numbers, and the multiple prop sequence slots are used to indicate an equipping sequence of using virtual props by the first virtual object.

The control display module 1830 is further configured to display, in response to a prop sequence setting operation in the pickup manner selection area, that the first virtual character picks up the first virtual prop.

As shown in FIG. 19, the apparatus further includes:

a storage area display module 1840, configured to: regularly display a prop equipping area, where the prop equipping area is used to display a virtual prop owned by the first virtual character; and display, after the first virtual character picks up the first virtual prop, the first virtual prop in the prop equipping area based on an equipping sequence indicated by the prop sequence setting operation.

In an embodiment, the prop equipping area includes multiple prop sub-areas, an i^{th} prop sub-area corresponds to an i^{th} prop sequence slot in the pickup manner selection area, and i is a positive integer.

The control display module 1830 is further configured to: receive a dragging operation on the first virtual prop, where the dragging operation is used to drag the first virtual prop to a j^{th} prop sequence slot, and j is a positive integer; and display that the first virtual character picks up the first virtual prop based on the dragging operation.

The storage area display module 1840 is further configured to display the first virtual prop in a j^{th} prop sub-area in the prop equipping area.

In an embodiment, the control display module 1830 is further configured to: receive a first slide operation starting from the j^{th} prop sub-area, where the first slide operation corresponds to a first slide direction and a first slide distance; and display, in response to that the first slide distance of the first slide operation in the first slide direction is greater than or equal to a first distance threshold, that the first virtual character discards the first virtual prop.

The storage area display module 1840 is further configured to cancel display of the first virtual prop in the j^{th} prop sub-area.

In an embodiment, a second virtual prop is displayed in a (j+1)^{th} prop sub-area of the prop equipping area, and the j^{th} prop sub-area is adjacent to the (j+1)^{th} prop sub-area.

The storage area display module 1840 is further configured to: receive a second slide operation starting from the j^{th} prop sub-area, where the second slide operation corresponds to a second slide direction and a second slide distance, and the second slide direction points from the j^{th} prop sub-area to the (j+1)^{th} prop sub-area; and display the second virtual prop in the j^{th} prop sub-area and display the first virtual prop in the (j+1)^{th} prop sub-area in response to that the second slide distance of the second slide operation in the second slide direction is greater than or equal to a second distance threshold.

In an embodiment, the i^{th} prop sub-area corresponds to an i^{th} consumed prop element control, and the i^{th} consumed prop element control is used to control a number of i^{th} consumed prop elements that match an i^{th} virtual prop in the i^{th} prop sub-area.

The storage area display module 1840 is further configured to: receive a trigger operation on the i^{th} consumed prop element control, where the trigger operation corresponds to a trigger duration, and the trigger duration is used to determine a number of i^{th} consumed prop elements that are discarded; and control, based on the trigger duration, the first virtual object to discard a first number of i^{th} consumed prop elements, and display a number change status of the i^{th} consumed prop element in the i^{th} prop sub-area.

In an embodiment, the storage area display module 1840 is further configured to: receive a binding operation for the i^{th} consumed prop element and the i^{th} virtual prop; receive a third slide operation on the i^{th} virtual prop when a binding relationship is established between the i^{th} consumed prop element and the i^{th} virtual prop, where the third slide operation corresponds to the first slide direction and a third slide distance; and display, in response to that the third slide distance of the third slide operation in the first slide direction is greater than or equal to the first distance threshold, that the first virtual character discards the i^{th} virtual prop and the multiple i^{th} consumed prop elements, and display that a number of i^{th} consumed prop elements is zero in the i^{th} prop sub-area.

In an embodiment, the virtual scene further includes a first consumed prop element; and

the selection area display module 1820 is further configured to display a corresponding deployment manner selection area of the first consumed prop element when the first virtual character and the first consumed prop element satisfy a prop pickup requirement, where the deployment manner selection area is used for providing the first virtual character with a deployment manner of a matching virtual prop during pickup of the first consumed prop element, and the matching virtual prop is a virtual prop that is owned by the first virtual character and that needs to consume the first consumed prop element to implement a prop function.

The control display module 1830 is further configured to: display, in response to a trigger operation on a first deployment manner in the deployment manner selection area, that the first virtual character picks up the first consumed prop element, and deploy a target virtual prop based on the first deployment manner by using the first consumed prop element.

In an embodiment, the deployment manner selection area includes multiple matching virtual props and a deployment cancellation control; and

the control display module 1830 is further configured to: display, in response to a selection operation on a k^{th} matching virtual prop in the deployment manner selection area, that the first virtual character picks up the first consumed prop element, and deploy the k^{th} matching virtual prop by using the first consumed prop element; or display, in response to a trigger operation on the deployment cancellation control in the deployment manner selection area, that the first virtual character picks up the first consumed prop element, and cancel deployment of the k^{th} matching virtual prop by using the first consumed prop element.

In conclusion, in the virtual prop control apparatus provided in this application, the first virtual character and the first virtual prop in the virtual scene are displayed, and the corresponding pickup manner selection area of the first virtual prop is displayed when the first virtual character and the first virtual prop satisfy the prop pickup requirement. The pickup manner selection area can provide the first virtual character with a pickup manner option of picking up the first virtual prop. Setting information such as the equipping manner of the picked-up first virtual prop and the deployment manner of the consumed prop element during pickup of the first virtual prop is determined, so that the first virtual character immediately determines how to control/use the first virtual prop when obtaining the first virtual prop. That the first virtual character picks up the first virtual prop based on the first pickup manner is displayed in response to the trigger operation on the first pickup manner in the pickup manner selection area. Compared with the way the first virtual character picks up the first virtual prop based on the default pickup rule, it can be avoided that the first virtual character performs an unnecessary equipping or deployment operation during pickup of the first virtual prop. This not only can effectively reduce several times a system responds to user operations and improve system resource utilization, but also can improve degrees of freedom and flexibility of operations of a player. Besides, this can avoid time consumption caused when the player re-adjusts the prop because the default pickup rule does not conform to a manner preferred by the player, and can improve human computer interaction efficiency.

The virtual prop control apparatus provided in the foregoing embodiment is described only using the division of the foregoing functional modules as an example. In actual application, the foregoing functions may be allocated to and completed by different functional modules as required. In other words, an internal structure of a device is divided into different functional modules to complete all or some of the functions described above. In addition, the virtual prop control apparatus provided in the foregoing embodiment belongs to the same idea as the embodiment of the virtual prop control method. For details of the specific implementation process thereof, refer to the method embodiment. Details are not described herein again.

FIG. 20 is a structural block diagram of a computer device 2000 according to an exemplary embodiment of this application. The computer device 2000 may be a smartphone, a tablet computer, a moving picture experts group audio layer III (MP3) player, a moving picture experts group audio layer IV (MP4) player, a notebook computer, or a desktop computer. The computer device 2000 may also be referred to as other names such as user equipment, a portable terminal, a laptop terminal, or a desktop terminal.

The computer device 2000 includes a processor 2001 and a memory 2002.

The processor 2001 may include one or more processing cores, for example, a 4-core processor or an 8-core processor. The processor 2001 may be implemented by using at least one hardware form of a digital signal processing (DSP), a field-programmable gate array (FPGA), and a programmable logic array (PLA). The processor 2001 may also include a main processor and a coprocessor. The main processor is a processor configured to process data in an awake state, and is also referred to as a central processing unit (CPU). The coprocessor is a processor with low power consumption configured to process data in a standby state. In some embodiments, the processor 2001 may be integrated with a graphics processing unit (GPU). The GPU is configured to render and draw content that needs to be displayed on a display screen. In some embodiments, the processor 2001 may further include an artificial intelligence (AI) processor. The AI processor is configured to process computing operations related to machine learning.

The memory 2002 may include one or more computer-readable storage mediums. The computer-readable storage medium may be non-transient. The memory 2002 may further include a high-speed random access memory and a nonvolatile memory, for example, one or more magnetic disk storage devices or flash storage devices. In some embodiments, the non-transitory computer-readable storage medium in the memory 2002 is configured to store at least one instruction. The at least one instruction is configured for being executed by the processor 2001 to implement the virtual prop control method provided in the method embodiments in this application.

In some embodiments, the computer device 2000 further includes another component. A person skilled in the art may understand that the structure shown in FIG. 20 does not constitute a limitation to the computer device 2000, and the computer device may include more or fewer components than those shown in the figure, or some components may be combined, or a different component deployment may be used.

In an embodiment, the computer-readable storage medium may include: a read only memory (ROM), a random access memory (RAM), a solid state drive (SSD), an optical disc, or the like. The random access memory may include a resistance random access memory (ReRAM) and a dynamic random access memory (DRAM). The sequence numbers of the embodiments of this application are merely for description purpose but do not imply the preference among the embodiments.

An embodiment of this application further provides a computer device, including a processor and a memory, the memory having a computer program stored therein, and the computer program being loaded and executed by the processor to implement the virtual prop control method according to any foregoing embodiment of this application.

An embodiment of this application further provides a computer-readable storage medium, the storage medium having a computer program stored therein, and the computer program being loaded and executed by a processor to implement the virtual prop control method according to any foregoing embodiment of this application.

An embodiment of this application further provides a computer program product, including computer programs, the computer program being stored in a computer-readable storage medium. A processor of a computer device reads the computer program from the computer-readable storage medium, and the processor executes the computer program, so that the computer device performs the virtual prop control method according to any foregoing embodiment.

A person of ordinary skill in the art may understand that all or some of the operations of the foregoing embodiments may be implemented by hardware, or may be implemented by a program instructing relevant hardware. The program may be stored in a computer-readable storage medium. The storage medium may be a read-only memory, a magnetic disk, an optical disc, or the like.

The foregoing descriptions are merely exemplary embodiments of this application, but are not intended to limit this application. Any modification, equivalent replacement, or improvement made within the spirit and principle of this application shall fall within the protection scope of this application.

What is claimed is:

1. A virtual prop control method performed by a computer device and the method comprising:
displaying a corresponding pickup manner selection area of a first virtual prop in a virtual scene, the pickup manner comprising at least one of an equipping manner of the first virtual prop and a deployment manner of a consumed prop element during pickup of the first virtual prop, and the consumed prop element being a virtual element consumable by the first virtual prop; and
in response to a trigger operation on a first pickup manner in the pickup manner selection area, causing a first virtual character to pick up the first virtual prop based on the first pickup manner.

2. The method according to claim 1, wherein the causing a first virtual character to pick up the first virtual prop based on the first pickup manner comprises:
in response to a consumed element deployment operation in the pickup manner selection area, deploying the first virtual prop with the consumed prop element.

3. The method according to claim 1, wherein the causing a first virtual character to pick up the first virtual prop based on the first pickup manner comprises:
in response to an automatic prop equipping operation in the pickup manner selection area, automatically equipping the first virtual prop.

4. The method according to claim 1, wherein the pickup manner selection area comprises multiple prop sequence slots that indicates an equipping sequence of the first virtual character using virtual props;
the method further comprises:
in response to a prop sequence setting operation in the pickup manner selection area, regularly displaying a prop equipping area including a virtual prop owned by the first virtual character; and
after the first virtual character picks up the first virtual prop, displaying the first virtual prop in the prop equipping area based on an equipping sequence indicated by the prop sequence setting operation.

5. The method according to claim 4, wherein the prop equipping area comprises multiple prop sub-areas, an i^{th} prop sub-area corresponds to an i^{th} prop sequence slot in the pickup manner selection area, and i is a positive integer;
the method further comprises:
receiving a dragging operation on the first virtual prop, wherein the dragging operation is used to drag the first virtual prop to a j^{th} prop sequence slot, and j is a positive integer; and
displaying that the first virtual character picks up the first virtual prop based on the dragging operation; and
displaying the first virtual prop in a j^{th} prop sub-area in the prop equipping area.

6. The method according to claim 1, wherein the method further comprises:
displaying a corresponding deployment manner selection area of a first consumed prop element in the virtual scene when the first virtual character and the first consumed prop element satisfy a prop pickup requirement; and
in response to a trigger operation on a first deployment manner in the deployment manner selection area, causing the first virtual character to pick up the first consumed prop element and deploying a target virtual prop based on the first deployment manner by using the first consumed prop element.

7. The method according to claim 6, wherein the deployment manner selection area comprises multiple matching virtual props and a deployment cancellation control; and
the causing the first virtual character to pick up the first consumed prop element and deploying a target virtual prop based on the first deployment manner by using the first consumed prop element comprises:
in response to a selection operation on a k^{th} matching virtual prop in the deployment manner selection area, causing the first virtual character to pick up the first consumed prop element, and deploying the k^{th} matching virtual prop by using the first consumed prop element; and
in response to a trigger operation on the deployment cancellation control in the deployment manner selection area, causing the first virtual character to pick up the first consumed prop element, and canceling deployment of the k^{th} matching virtual prop by using the first consumed prop element.

8. A computer device, comprising a processor and a memory, the memory having a computer program stored therein, and the computer program being loaded and executed by the processor to implement a virtual prop control method including:
displaying a corresponding pickup manner selection area of a first virtual prop in a virtual scene, the pickup manner comprising at least one of an equipping manner of the first virtual prop and a deployment manner of a consumed prop element during pickup of the first virtual prop, and the consumed prop element being a virtual element consumable by the first virtual prop; and
in response to a trigger operation on a first pickup manner in the pickup manner selection area, causing a first virtual character to pick up the first virtual prop based on the first pickup manner.

9. The computer device according to claim 8, wherein the causing a first virtual character to pick up the first virtual prop based on the first pickup manner comprises:
in response to a consumed element deployment operation in the pickup manner selection area, deploying the first virtual prop with the consumed prop element.

10. The computer device according to claim 8, wherein the causing a first virtual character to pick up the first virtual prop based on the first pickup manner comprises:
in response to an automatic prop equipping operation in the pickup manner selection area, automatically equipping the first virtual prop.

11. The computer device according to claim 8, wherein the pickup manner selection area comprises multiple prop sequence slots that indicates an equipping sequence of the first virtual character using virtual props;
the method further comprises:
in response to a prop sequence setting operation in the pickup manner selection area, regularly displaying a prop equipping area including a virtual prop owned by the first virtual character; and
after the first virtual character picks up the first virtual prop, displaying the first virtual prop in the prop equipping area based on an equipping sequence indicated by the prop sequence setting operation.

12. The computer device according to claim 11, wherein the prop equipping area comprises multiple prop sub-areas, an i^{th} prop sub-area corresponds to an i^{th} prop sequence slot in the pickup manner selection area, and i is a positive integer;
the method further comprises:
receiving a dragging operation on the first virtual prop, wherein the dragging operation is used to drag the first virtual prop to a j^{th} prop sequence slot, and j is a positive integer; and
displaying that the first virtual character picks up the first virtual prop based on the dragging operation; and
displaying the first virtual prop in a j^{th} prop sub-area in the prop equipping area.

13. The computer device according to claim 8, wherein the method further comprises:
displaying a corresponding deployment manner selection area of a first consumed prop element in the virtual scene when the first virtual character and the first consumed prop element satisfy a prop pickup requirement; and
in response to a trigger operation on a first deployment manner in the deployment manner selection area, causing the first virtual character to pick up the first consumed prop element and deploying a target virtual prop based on the first deployment manner by using the first consumed prop element.

14. The computer device according to claim 13, wherein the deployment manner selection area comprises multiple matching virtual props and a deployment cancellation control; and
the causing the first virtual character to pick up the first consumed prop element and deploying a target virtual prop based on the first deployment manner by using the first consumed prop element comprises:
in response to a selection operation on a k^{th} matching virtual prop in the deployment manner selection area, causing the first virtual character to pick up the first consumed prop element, and deploying the k^{th} matching virtual prop by using the first consumed prop element; and
in response to a trigger operation on the deployment cancellation control in the deployment manner selection area, causing the first virtual character to pick up the first consumed prop element, and canceling deployment of the k^{th} matching virtual prop by using the first consumed prop element.

15. A non-transitory computer-readable storage medium, having a computer program stored therein, the computer program being loaded and executed by a processor of a computer to implement a virtual prop control method including:
displaying a corresponding pickup manner selection area of a first virtual prop in a virtual scene, the pickup manner comprising at least one of an equipping manner of the first virtual prop and a deployment manner of a consumed prop element during pickup of the first virtual prop, and the consumed prop element being a virtual element consumable by the first virtual prop; and
in response to a trigger operation on a first pickup manner in the pickup manner selection area, causing a first virtual character to pick up the first virtual prop based on the first pickup manner.

16. The non-transitory computer-readable storage medium according to claim 15, wherein the causing a first virtual character to pick up the first virtual prop based on the first pickup manner comprises:
in response to a consumed element deployment operation in the pickup manner selection area, deploying the first virtual prop with the consumed prop element.

17. The non-transitory computer-readable storage medium according to claim 15, wherein the causing a first virtual character to pick up the first virtual prop based on the first pickup manner comprises:
in response to an automatic prop equipping operation in the pickup manner selection area, automatically equipping the first virtual prop.

18. The non-transitory computer-readable storage medium according to claim 15, wherein the pickup manner selection area comprises multiple prop sequence slots that indicates an equipping sequence of the first virtual character using virtual props;
the method further comprises:
in response to a prop sequence setting operation in the pickup manner selection area, regularly displaying a prop equipping area including a virtual prop owned by the first virtual character; and
after the first virtual character picks up the first virtual prop, displaying the first virtual prop in the prop equipping area based on an equipping sequence indicated by the prop sequence setting operation.

19. The non-transitory computer-readable storage medium according to claim 18, wherein the prop equipping area comprises multiple prop sub-areas, an i^{th} prop sub-area corresponds to an i^{th} prop sequence slot in the pickup manner selection area, and i is a positive integer;
the method further comprises:
receiving a dragging operation on the first virtual prop, wherein the dragging operation is used to drag the first virtual prop to a j^{th} prop sequence slot, and j is a positive integer; and
displaying that the first virtual character picks up the first virtual prop based on the dragging operation; and
displaying the first virtual prop in a j^{th} prop sub-area in the prop equipping area.

20. The non-transitory computer-readable storage medium according to claim 15, wherein the method further comprises:
displaying a corresponding deployment manner selection area of a first consumed prop element in the virtual scene when the first virtual character and the first consumed prop element satisfy a prop pickup requirement; and
in response to a trigger operation on a first deployment manner in the deployment manner selection area, causing the first virtual character to pick up the first consumed prop element and deploying a target virtual prop based on the first deployment manner by using the first consumed prop element.
